(19) United States
(12) Patent Application Publication
(10) Pub. No.: US 2020/0050415 A1
(43) Pub. Date: Feb. 13, 2020

(54) CONTENT TRANSMISSION SYSTEM, DISPLAY DEVICE, CONTENT TRANSMISSION METHOD, AND RECORDING MEDIUM STORING PROGRAM

(71) Applicant: SHARP KABUSHIKI KAISHA, Osaka (JP)

(72) Inventor: Kohji Kumetani, Osaka (JP)

(21) Appl. No.: 16/534,717

(22) Filed: Aug. 7, 2019

(30) Foreign Application Priority Data
Aug. 9, 2018 (JP) 2018-150579

(51) Int. Cl. G06F 3/147; G06Q 30/02

(52) U.S. Cl. CPC G06F 3/147; H04L 67/42; G06Q 30/0277; G06Q 30/0281

(57) ABSTRACT

Provided is a content transmission system including a content transmission device and a plurality of display devices. The content transmission device includes a content storage that stores content, a group storage that performs grouping of the plurality of display devices into one or more groups, and stores information relating to the grouping, and a first controller that transmits, to one display device among the grouped display devices, grouping inform nation relating to the grouped display devices, and the content. The one display device includes a receiver that receives the grouping information and the content from the content transmission device, and a second controller that transmits the received content to another display device included in the group based on the grouping information.

### BACKGROUND OF THE INVENTION

### Field of the Invention

The present invention relates to a content transmission system and the like.

### Description of the Background Art

In recent years, digital signage, in which a display device is arranged in a location with many people, such as a shopping center, and content such as advertisements is displayed on the display device, has become widespread. Furthermore, there are many cases where shopping centers exist in other locations, and digital signage has been introduced at each of the locations. Accordingly, cases where large numbers of display devices are managed have become more common.

For example, a server that manages content can sometimes manage a plurality of display devices that serve as clients. At this time, when content is distributed from the server to the plurality of display devices, it takes a long time to complete content distribution. Furthermore, there is a concern that congestion may occur on the transmission path from the server to the display devices.

Therefore, techniques have been proposed for efficiently distributing content. For example, an invention has been disclosed wherein a server includes a file transfer controller, a client also includes a file transfer controller, and a client transfers a file in response to a request from another client (for example, see Japanese Unexamined Patent Application Publication No. 2007-018294).

Furthermore, an invention has been disclosed wherein data transfer between clients is implemented by a relay management device connected on the same subnetwork (for example, see Japanese Unexamined Patent Application Publication No. 2014-059706).

However, depending on the network configuration of the display devices, not all of the display devices are necessarily connected to the same subnetwork, and there is a problem that flexible transmission of content cannot be implemented depending on the form of connection between the display devices.

The present invention has been made in view of the conventional problems described above, and has an object of providing a content transmission system capable of efficiently transmitting content when content is transmitted from a content transmission device that transmits content to a display device.

### SUMMARY OF THE INVENTION

In order to solve the problems described above, a content transmission system of the present invention includes a content transmission device and a plurality of display devices. The content transmission device includes a storage that stores content, and a first controller that performs grouping of the plurality of display devices into one or more groups, stores grouping information, which is information relating to the grouping, in the storage, and transmits the grouping information and the content to one display device among the grouped display devices. The one display device includes a second controller that receives the grouping information and the content from the content transmission device, and transmits the received content to another display device included in the group based on the grouping information.

A display device of the present invention is connectable to a content transmission device that manages a plurality of display devices by grouping the display devices into one or more groups, and includes a controller that receives content and grouping information, which is information relating to the grouped display devices, from the content transmission device, and transmits the content to another display device included in the group based on the grouping information.

A content transmission method of the present invention is for a display device connectable to a content transmission device that manages a plurality of display devices by grouping the display devices into one or more groups, the method including: receiving content and grouping information, which is information relating to the grouped display devices, from the content transmission device; and transmitting the content to another display device included in the group based on the grouping information.

A program of the present invention causes a computer of a display device connectable to a content transmission device that manages a plurality of display devices by grouping the display devices into one or more groups, to implement the content transmission method described above.

According to the content transmission system of the present invention, a content transmission device that transmits content performs grouping of display devices, and transmits content and grouping information to one display device included in a group. Furthermore, the one display device transmits content to another display device in the group. Therefore, a server that manages the content is not required to transmit the content to all of the display devices, which enables an efficient content transmission.

### BRIEF DESCRIPTION OF THE DRAWINGS

FIG. 1 is a diagram for describing an overall configuration of a content transmission system according to a first embodiment.

FIG. 2 is a diagram for describing a functional configuration of a management server device according to the first embodiment.

FIG. 3 is a diagram showing an example of a data configuration of display device information in the first embodiment.

FIG. 4 is a diagram showing an example of a data configuration of belonging group information in the first embodiment.

FIG. 5 is a diagram showing an example of a data configuration of group information in the first embodiment.

FIG. 6 is a diagram for describing a functional configuration of a display device according to the first embodiment.

FIG. 7 is a diagram showing an example of a data configuration of slave display device information in the first embodiment.

FIG. 8 is a diagram showing an example of a data configuration of master display device information in the first embodiment.

FIG. 9 is a sequence diagram in the first embodiment.

FIG. 10 is a flow diagram for describing the flow of main processing in the management server device in the first embodiment.

FIG. 11 is a flow diagram for describing the flow of main processing in the management server device in the first embodiment.

FIG. 12 is a flow diagram for describing the flow of main processing in the display device in the first embodiment.

FIG. 13 is a flow diagram for describing the flow of content transmission processing in the display device in the first embodiment.

FIG. 14 is a flow diagram for describing the flow of content reception processing in the display device in the first embodiment.

FIG. 15 is a flow diagram for describing the flow of content display processing in the display device in the first embodiment.

FIG. 16 is a diagram showing an operation example in the first embodiment.

FIG. 17 is a diagram showing an operation example in the first embodiment.

FIG. 18 is a diagram showing an operation example in the first embodiment.

FIG. 19 is a diagram showing an operation example in the first embodiment.

FIG. 20 is a diagram for describing a functional configuration of a management server device according to a second embodiment.

FIG. 21 is a diagram showing an example of a data configuration of schedule information in the second embodiment.

FIG. 22 is a diagram for describing a functional configuration of a display device according to the second embodiment.

FIG. 23 is a sequence diagram in the second embodiment.

FIG. 24 is a flow diagram for describing the flow of content display processing in the display device in the second embodiment.

FIG. 25 is a diagram for describing a functional configuration of a display device according to a third embodiment.

FIG. 26 is a diagram showing an example of a data configuration of belonging group extended information in the first embodiment.

FIG. 27 is a sequence diagram in the third embodiment.

FIG. 28 is a flow diagram for describing the flow of main processing in a management server device in the third embodiment.

FIG. 29 is a flow diagram for describing the flow of main processing in the display device in the third embodiment.

FIG. 30 is a diagram showing an operation example in the third embodiment.

FIG. 31 is a diagram for describing a functional configuration of a management server device according to a fourth embodiment.

FIG. 32 is a diagram showing an example of a data configuration of group type information in the fourth embodiment.

FIG. 33 is a diagram showing an example of a data configuration of schedule information in the fourth embodiment.

FIG. 34 is a diagram for describing a functional configuration of a display device according to a fourth embodiment.

FIG. 35 is a diagram for describing a functional configuration of a display device according to a fifth embodiment.

FIG. 36 is a diagram showing an operation example in the fifth embodiment.

### DESCRIPTION OF THE PREFERRED EMBODIMENTS

Hereunder, embodiments of the present invention will be described with reference to the drawings. In the present embodiment, a content transmission system to which the present embodiment is applied is described as an example.

### 1. First Embodiment

### 1.1 Overall Configuration

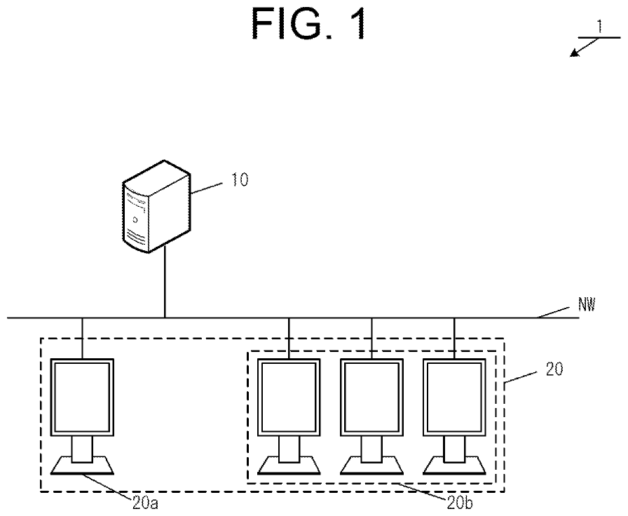

First, an overall configuration of the content transmission system 1 according to the present embodiment will be described based on FIG. 1. As shown in FIG. 1, in the content transmission system 1, a management server device 10 and a plurality of display devices 20 are connected via a network NW. The display devices 20 include a master display device 20a and slave display devices 20b. The functional configuration of the master display device 20a and the slave display devices 20b is the same, but their behavior when transmitting content is different.

In FIG. 1, the management server device 10 and the display devices 20 are illustrated as being connected by the same network via a local area network (LAN), which serves as the network NW. However, other connection configurations are possible. For example, the management server device 10 and the display devices 20 may be connected via an external network such as the Internet. Furthermore, the devices may be connected by another means capable of communication (for example, a serial interface such as RS-232C) instead of a LAN.

The management server device 10 is a server having a function as a device (content transmission device) that stores content to be transmitted to the display devices 20 and which transmits content to the display devices 20. The management server device 10, for example, is used by digital signage service providers and those that wish to transmit content, such as signage system administrators and advertisers.

The display device 20 is a device for displaying content transmitted from the management server device 10. For example, the display device 20 has a configuration in which a video output device, such as a display, and a control device that controls the output of the video output device are integrated. Furthermore, the video output device and the control device may be configured as separate devices.

In the present embodiment, content refers to still images and videos capable of being displayed by the display device 20. This content is stored as still image files and video files in the management server device 10. Furthermore, the display device 20 receives files stored in the management server device 10. The display device 20 displays video content on the display device 20 by performing playback and output processing of a received video file.

Furthermore, in terms of the content, content may be included in which a plurality of content is simultaneously displayed on the display device 20. In the present embodiment, content having an object of simultaneously displaying a plurality of content on the display device 20 in this manner is referred to as a “program”. A program is configured by screen layout information which defines how the display area of the display device 20 is divided, a content list that defines, for each area, the content which is displayed in the area, and the video and still image content included in the content list. When the display device 20 receives program content, it divides the display area based on the screen layout information, and displays in each area the content defined by the content list. The management server device 10 stores the program as a program file, and transmits the program file to the display device 20. The display device 20 displays the program based on the received program file.

As a method of transmitting the content stored in the management server device 10 to the display devices 20, in the present embodiment, the management server device 10 transmits the content stored in the management server device 10 to the master display device 20a. Furthermore, the master display device 20a transmits the content received from the management server device 10 to the slave display devices 20b. As a result, the management server device 10 does not need to transmit the content to all of the display devices 20 managed by the management server device 10, and the load of the management server device 10 can be reduced.

Further, in the present embodiment, the management server device 10 manages the display devices 20 by grouping them into one or more groups based on an attribute of the display devices 20. The attribute referred to here is determined by an administrator or system of the content transmission system 1. For example, the attribute is assigned based on an installation location, a store name, or the nature of the content. Moreover, the same content is transmitted to the display devices belonging to the same group. In addition, a group may be assigned a “group name”.

For example, suppose that a plurality of escalators are installed inside a store that uses the content transmission system 1, and that display devices 20 are installed in front of a number of the escalators. At this time, by grouping the display devices 20 installed in front of an escalator, the same content is transmitted to the display devices 20 in the group. The group name “in front of escalator” may be assigned to this group.

Further, the management server device 10 is capable of specifying, from among the content stored in the management server device 10, the content to be displayed on the display devices 20 belonging to the “in front of escalator” group based on information relating to the group, such as the group name.

The present embodiment is described assuming that a content group is specified by the group name. Specifically, for example, the management server device 10 stores content files inside a folder having a folder name of “in front of escalator” (hereinafter, written in the form ““in front of escalator” folder”). Then, the files stored in the “in front of escalator” folder are transmitted to the group assigned the group name “in front of escalator” (hereinafter, written in the form ““in front of escalator” group”). In such a manner, the content specified by the “in front of escalator” group name can be transmitted to the display devices 20 belonging to the “in front of escalator” group. The content transmitted to display devices 20 belonging to the same group is referred to as “group content”.

The group content does not have to be specified by a group name. For example, the management sever device 10 may uniquely assign an ID to a group, and specify the group content based on the assigned ID. For example, the management server device 10 may store a correspondence table in which the group and group content are associated with each other.

Furthermore, a single display device 20 may belong to a plurality of groups. For example, if a certain display device 20 belongs to the “in front of escalator” group and the “summer sale” group, the display device 20 receives the content for the “in front of escalator” group and for the “summer sale” group, and displays the respective content.

The management server device 10 determines, for each group, the display device 20 that serves as the master display device 20a, and the display devices 20 that serve as the slave display devices 20b. Therefore, a display device 20 may serve as the master display device 20a in a certain group, but serve as a slave display device 20b in another group. Furthermore, a single display device 20 may serve as the master display device 20a in a plurality of groups.

### 1.2 Functional Configuration

### 1.2.1 Functional Configuration of Management Server Device

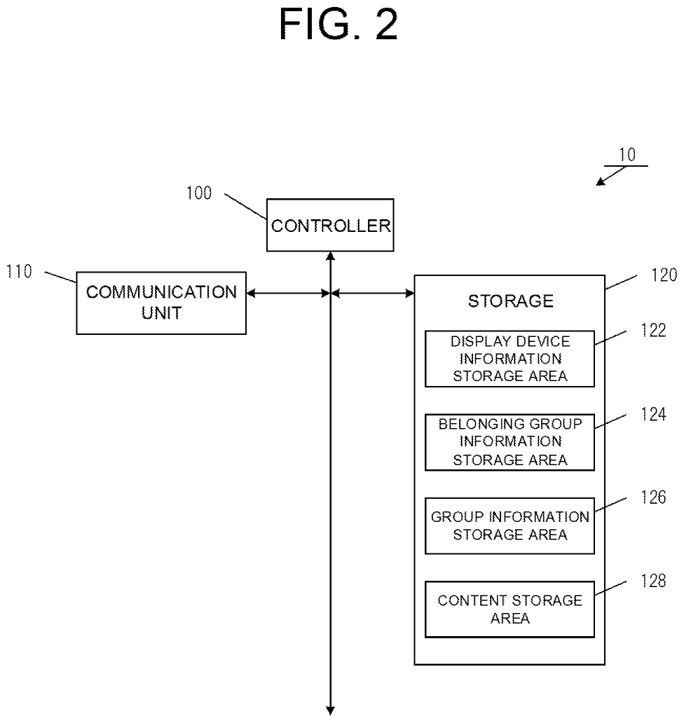

The functional configuration of the management server device 10 will be described with reference to FIG. 2. As shown in FIG. 2, the management server device 10 includes a controller 100, a communication unit 110, and a storage 120.

The controller 100 is a functional unit for controlling the management server device 10 as a whole. The controller 100 realizes various functions by reading and executing various programs, and is constituted by one or more computation devices (for example, a central processing unit (CPU)).

The communication unit 110 is a functional unit that enables the management server device 10 to perform communication with an external device. For example, the communication unit 110 is constituted by a Network Interface Card (NIC) used by a wired/wireless LAN. The communication method may be an Ethernet (registered trademark) or IEEE 802.11a/b/g/n.

The storage 120 is a functional unit that stores various programs and various data required for operation of the management server device 10. The storage 120 is constituted by, for example, a semiconductor memory such as a solid state drive (SSD) or hard disk drive (HDD).

In the storage 120, a display device information storage area 122, a belonging group information storage area 124, a group information storage area 126, and a content storage area 128 are further secured.

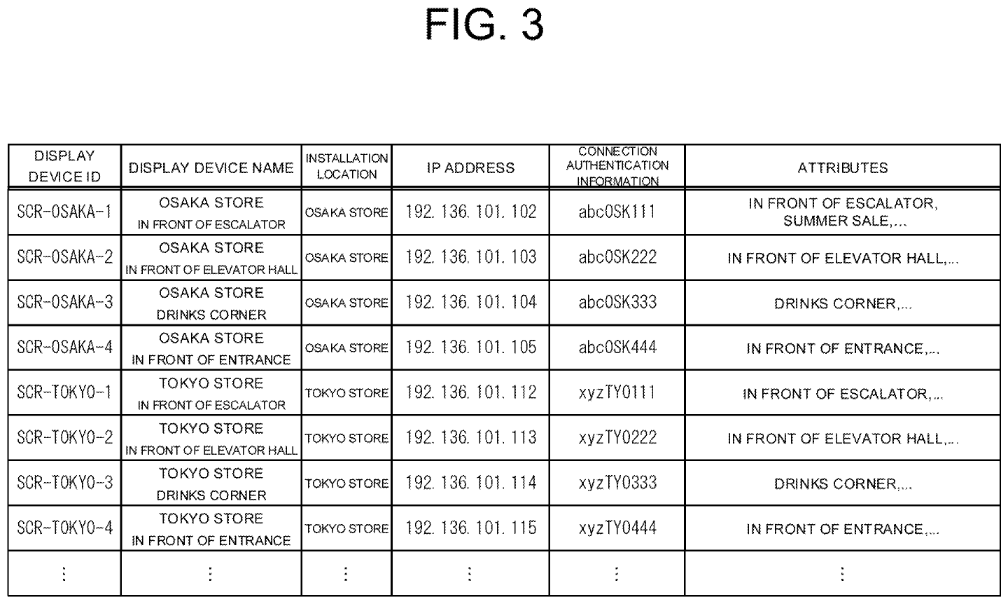

The display device information storage area 122 is an area that stores display device information, which is information relating to the display devices 20 managed by the management server device 10. The display device information is information which is stored in advance by an administrator of the content transmission system 1 and the like. FIG. 3 is a diagram showing display device information in the present embodiment. As shown in FIG. 3, the display device information records a display device ID (for example “SCR-OSAKA-1”) for specifying a display device 20, a display device name (for example, “Osaka store, in front of escalator”) which is the name of the display device 20, an installation location (for example “Osaka store”) which indicates the location in which the display device 20 is installed, an IP address (for example, “192.136.101.102”) for specifying the display device 20 on the network NW of the content transmission system 1, connection authentication information (for example, “abcOSK111”) which is information for certifying that the file transmission source is a legitimate display device 20, and attributes (for example, “in front of escalator, summer sale, . . . ”) of the display device 20.

The connection authentication information stores information for generating, for example, a password, a secret key of the display device 20, or a one-time password according to the authentication method used by the content transmission system 1. The present embodiment is described assuming that a password is stored as the connection authentication information.

An attribute is information relating to a display device, and is information which is used to perform grouping. As mentioned above, in addition to information relating to the store name and the nature of the content to be displayed, information relating to the customer type targeted by the displayed content (for example, “female” and “20s”), and information relating to the number of people who view the display device (for example, “many viewers” or “few viewers”) and the like may be stored. Furthermore, information such as the resolution of the display unit of the display device, the orientation (portrait or landscape) of the display unit of the display device, and the size of the display device itself (the lengths of the long side and short side of the display unit) may also be stored.

In addition to the information mentioned above, the display device information storage area 122 may store information for specifying a display device 20, and information for connecting to the display device 20. For example, in a case where a file is to be received, a port number may be stored when a specific port number is to be used. Furthermore, information may be stored relating to the performance of the display device 20 (for example, the performance of the controller 200 of the display device 20, the capacity of a random access memory (RAM), the communication method and the like).

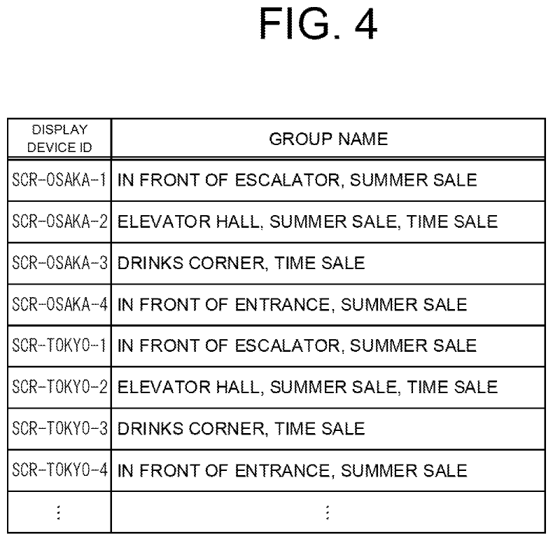

The belonging group information storage area 124 is an area that stores belonging group information, which is information that stores information relating to the groups to which the display devices 20 belong. The belonging group information is information which is pre-recorded by an administrator of the content transmission system 1 and the like. FIG. 4 is a diagram showing belonging group information in the present embodiment. As shown in FIG. 4, the belonging group information stores a display device ID (for example, “SCR-OSAKA-1”) for specifying the display device 20, and group names (for example, “in front of escalator, summer sale”) for specifying the groups to which the display devices 20 belong.

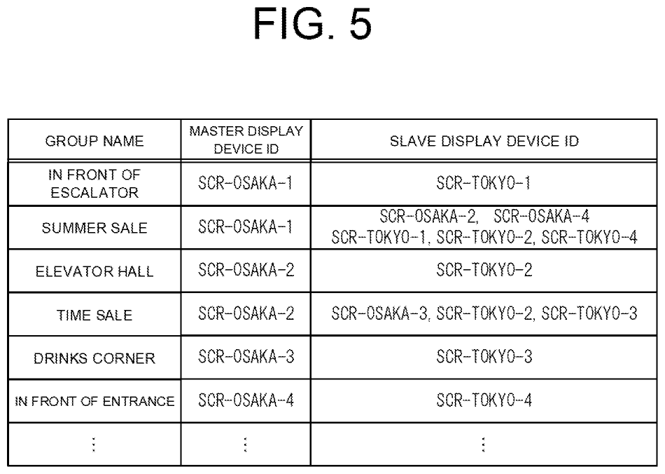

The group information storage area 126 is an area that stores group information, which is information in which the display devices 20 have been grouped based on the belonging group information. FIG. 5 is a diagram showing group information in the present embodiment. As shown in FIG. 5, the group information stores a group name for example, “in front of escalator”) for specifying a group, a master display device ID (for example, “SCR-OSAKA-1”) for specifying the display device 20 that serves as the master display device 20a, and slave display device IDs (for example, “SRC-TOKYO-1”) for specifying the display devices 20 that serve as slave display devices 20b.

A single group may include a plurality of master display devices 20a. In this case, the group information is stored so as to include slave display devices 20b for each of the master display devices 20a. In this manner, the number of slave display devices 20b to which a single master display device 20a transmits content is reduced, even in a case where a large number of display devices 20 belong to a single group. Therefore, the content transmission processing between display devices 20 can be distributed.

The content storage area 128 is an area that stores content. The content is stored in association with information relating to the group. As already described, for example, files representing the content are stored in a folder having the group name as the folder name in a case where the group name is used as the information relating to the group. In this manner, the group name, which represents information relating to the group, and the content are associated with each other.

The content storage area 128 may also store files (video files, still image files, and program files) including the group name as metadata, or files having the group name as the file name. That is to say, the content storage area 128 may store the content of the video files, still image files, and program files as is without preparing a folder having the group name as the folder name. In this case, there is an advantage that files do not have to be separately prepared in each folder if certain content is shared by a plurality of groups.

Furthermore, in the description above, the group name is used as the information relating to the group. However, information other than the group name may be used. For example, if a group identification code includes information capable of uniquely identifying the group as the group information, the group identification code and the content may be associated with each other. In this case, the information relating to the group and the content are associated with each other by storing files representing the content in a folder having the group identification code as the folder name, or by storing files that include the group identification code as metadata.

The content may also be stored in the content storage area 128 by methods other than those described above, as long as the information relating to the group and the content can be associated with each other. In this manner, as a result of the information relating to the group and the content being associated with each other, the group content can be specified based on information relating to the group, such as the group name.

### 1.2.2 Functional Configuration of Display Device

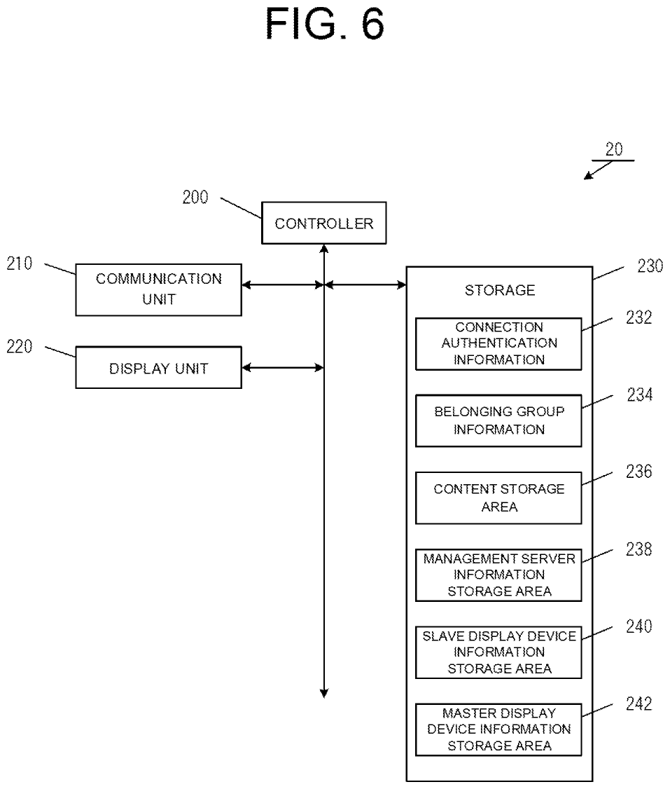

The functional configuration of a display device 20 will be described with reference to FIG. 6. As shown in FIG. 6, the display device 20 includes a controller 200, a communication unit 210, a display unit 220, and a storage 230.

The controller 200 is a functional unit for controlling the display device 20 as a whole. The controller 200 realizes various functions by reading and executing various programs, and is constituted by one or more computation devices (for example, a CPU).

The communication unit 210 is a functional unit that enables the display device 20 to perform communication with an external device. For example, the communication unit 110 is constituted by an NIC used by a wired/wireless LAN. The communication method may be an Ethernet or IEEE 802.11a/b/g/n.

The display unit 220 is a functional unit for outputting content. For example, the display unit 220 is constituted by a display device such as a liquid crystal display (LCD) or an organic electro luminescence (EL) display.

The storage 230 is a functional unit that stores various programs and various data required for operation of the display device 20. The storage 230 is constituted by, for example, a semiconductor memory such as an SSD or a hard disk drive (HDD).

The storage 230 stores connection authentication information 232 and belonging group information 234, and further secures a content storage area 236, a management server information storage area 238, a slave display device information storage area 240, and a master display device information storage area 242.

The connection authentication information 232 is information for authenticating the display device 20 of a connection source in a case where another display device 20 connects via the communication unit 210. In the present embodiment, a password is stored. When the other display device 20 is connected, the display device 20 serving as the connection destination requests the display device 20 of the connection source for a password, which represents the connection authentication information. When the password is received from the other display device 20, the received password and the password stored as the connection authentication information 232 are compared. The display device 20 of the connection source is authenticated if the passwords match each other.

The connection authentication information 232 may also store information for issuing a secret key or a one-time password depending on the authentication method. The type of information used as the connection authentication information 232 depends on the authentication method used by the content transmission system 1.

The belonging group information 234 is information relating to the group to which the display device 20 belongs. In the present embodiment, the belonging group information 234 stores, among the belonging group information stored by the belonging group information storage area 124, the group name corresponding to the display device ID of the display device 20.

The content storage area 236 is a storage area that stores content corresponding to the group to which the display device 20 belongs. Some or all of the files stored in the content storage area 128 are stored.

The management server information storage area 238 is information relating to the management server device 10. For example, the IP address of the management server device 10 is stored. When content is received from the management server device 10, the management server device 10 is authenticated if the IP address of the management server device 10 serving as the transmission source matches the management server information storage area 238. The management server information storage area 238 may additionally store information relating to a connection such as the port number used in the connection with the management server device 10, and information unique to the management server device 10, such as the display device name of the management server device 10.

The slave display device information storage area 240 is an area that stores slave display device information, which is information relating to the slave display devices 20b belonging to the same group which serve as the transmission destinations of the group content when the display device 20 is the master display device 20a. The slave display device information is information transmitted from the management server device 10. Furthermore, the slave display device information is information relating to the display devices 20 grouped by the management server device 10, and represents grouping information.

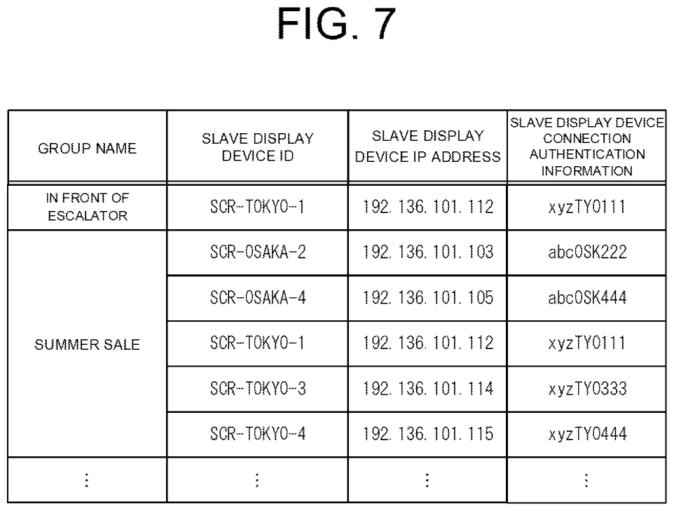

FIG. 7 is a diagram showing slave display device information in the present embodiment. As shown in FIG. 7, the slave display device information stores a group name (for example, “in front of escalator”) for specifying a group, a slave display device ID (for example, “SCR-TOKYO-1”) for specifying the slave display device 20b, an IP address (for example, “192.136.101.112”) for specifying the slave display device on the network NW of the content transmission system 1, and the connection authentication information (for example, “xyzTYO111”) stored in the slave display device.

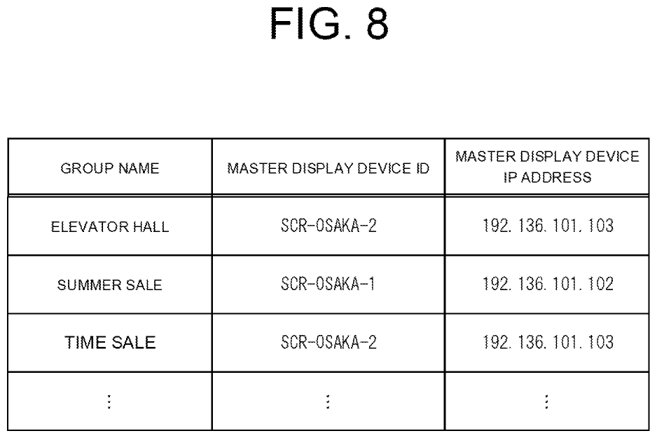

The master display device information storage area 242 is an area that stores master display device information, which represents information relating to the master display device 20a belonging to the same group if the display device 20 is a slave display device 20b. The master display device information is information transmitted from the management server device 10. FIG. 8 is a diagram showing master display device information in the present embodiment. As shown in FIG. 8, the master display device information stores a group name (for example, “elevator hall”) for specifying a group, a master display device ID (for example, “SCR-OSAKA-2”) for specifying the master display device 20a, and an IP address (for example, “192.136.101.103”) for specifying the master display device on the network NW of the content transmission system 1.

The storage 230 may store, in addition to the information described above, information unique to the display device 20, such as a display device ID, a display device name, an IP address, and an attribute.

### 1.3 Processing Flow

### 1.3.1 Description of Data Transmitted and Received

A processing flow in the present embodiment will be described with reference to the drawings. Even if outside the description of the present specification, the order of the steps may be changed or some steps may be omitted to an extent that does not cause inconsistencies.

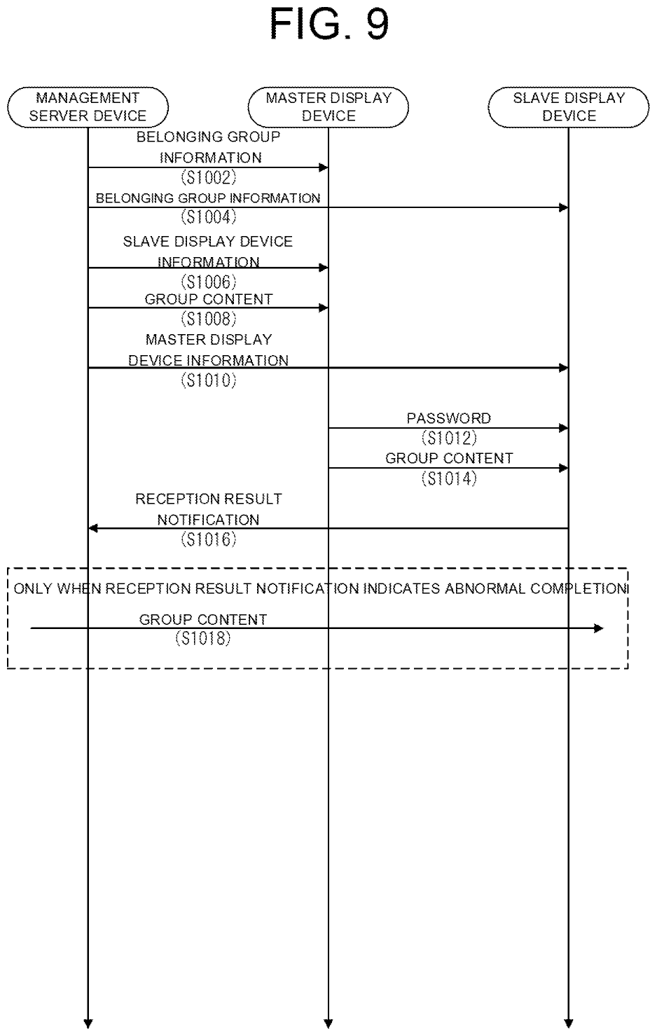

First, the data transmitted and received in the content transmission system 1 of the present embodiment will be described with reference to FIG. 9. FIG. 9 is a diagram showing the data transmitted and received within the same group. Therefore, the same data transmission and reception is performed in the other groups. Furthermore, for the purpose of explanation, only one master display device 20a and slave display device 20b are depicted in FIG. 9. However, if a plurality of master display devices 20a and slave display devices 20b belong to the group, data transmission and reception is performed for each master display device 20a and slave display device 20b.

First, the management server device 10 reads the belonging group information storage area 124, and transits belong group information to the display devices 20 included the content transmission system 1. Specifically, for each of the display devices 20, the group name associated with the display device ID of the display device 20 is transmitted. As a result, the display device 20 is capable of acquiring the group name of the group to which it belongs (S1002, S1004). FIG. 9 depicts a drawing in which the belonging group information is transmitted to both the master display device 20a and the slave display device 20b. However, the master display device 20a and the slave display device 20b are not yet determined at this time. Therefore, the management server device 10 transmits the belonging group information to all of the display devices 20 managed by the management server device 10, irrespective of whether they serve as the master display device 20a or the slave display device 20b.

Next, the management server device 10 transmits to each group the slave display device information, which represents grouping information, to the master display device 20a included in the group (S1006). In terms of the generation of the slave display device information, the controller 100 of the management server device 10 firstly extracts from the display device information storage area 122 the display device information associated with each slave display device ID stored in the group information storage area 126. Then, the controller 100 generates the slave display device information by setting the display device ID, IP address, and connection authentication information in the display device information as the slave display device ID, the slave display device IP address, and the slave display device connection authentication information, respectively, and then adding the group name. The master display device 20a is capable of specifying the slave display device 20b belonging to the same group as a result of receiving the slave display device information from the management server device 10.

Then, the management server device 10 reads the group content for each group from the content storage area 128, and transmits the content to the master display device 20a (S1008).

Next, the management server device 10 transmits to each group the master display device information to the slave display device 20b (S1010). In terms of the generation of the master display device information, the controller 100 of the management server device 10 firstly extracts from the display device information storage area 122 the display device information associated with each master display device ID stored in the group information storage area 126. Then, the controller 100 generates the master display device information by setting the display device ID and IP address in the display device information as the master display device ID and the master display device IP address, respectively, and then adding the group name. The slave display device 20b is capable of specifying the master display device 20a belonging to the same group as a result of receiving the master display device information from the management server device 10.

Next, the master display device 20a connects to the slave display device 20b based on the slave display device information. In this case, a password representing the connection authentication information of the slave display device 20b is transmitted (S1012). If the master display device 20a is authenticated by the slave display device 20b, the group content is read from the content storage area 236 and then transmitted to the slave display device 20b (S1014).

Next, the slave display device 20b transmits to the management server device 10b a reception result notification that includes a reception result indicating whether content reception has been completed normally (S1016). The reception result indicates either a “normal completion” result, which indicates that content reception has been completed normally, or an “abnormal completion” result, which indicates content reception has not been completed normally.

When the management server device 10 receives the reception result notification from the slave display device 20b and the reception result indicates a “abnormal completion”, the group content is directly transmitted from the management server device 10 to the slave display device 20b (S1018). In such a manner, the group content can be received from the management server device 10 even in those cases where the slave display device 20b was unable to receive the group content from the master display device 20a. If the slave display device 20b receives the group content from the management server device 10, it can be verified by means of management server information whether or not the connection source device is the management server device 10.

### 1.3.2. Flow of Main Processing in Management Server Device

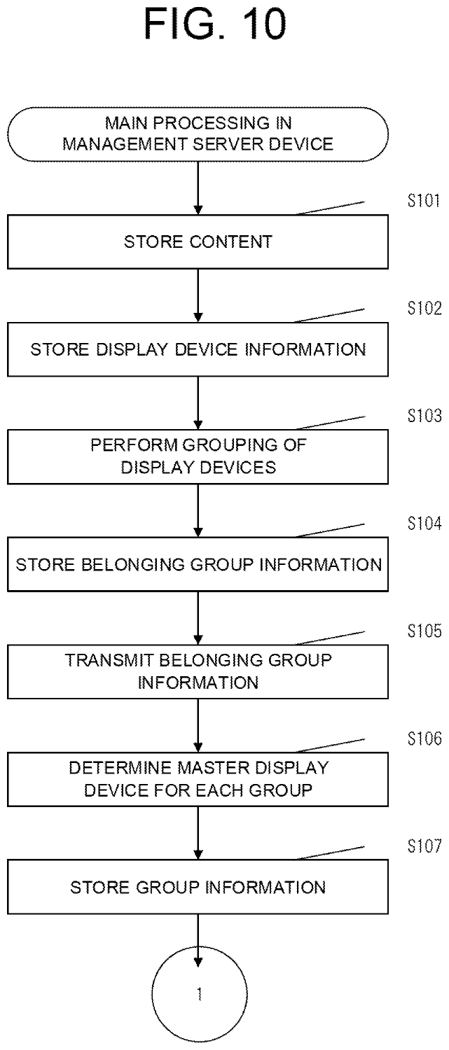

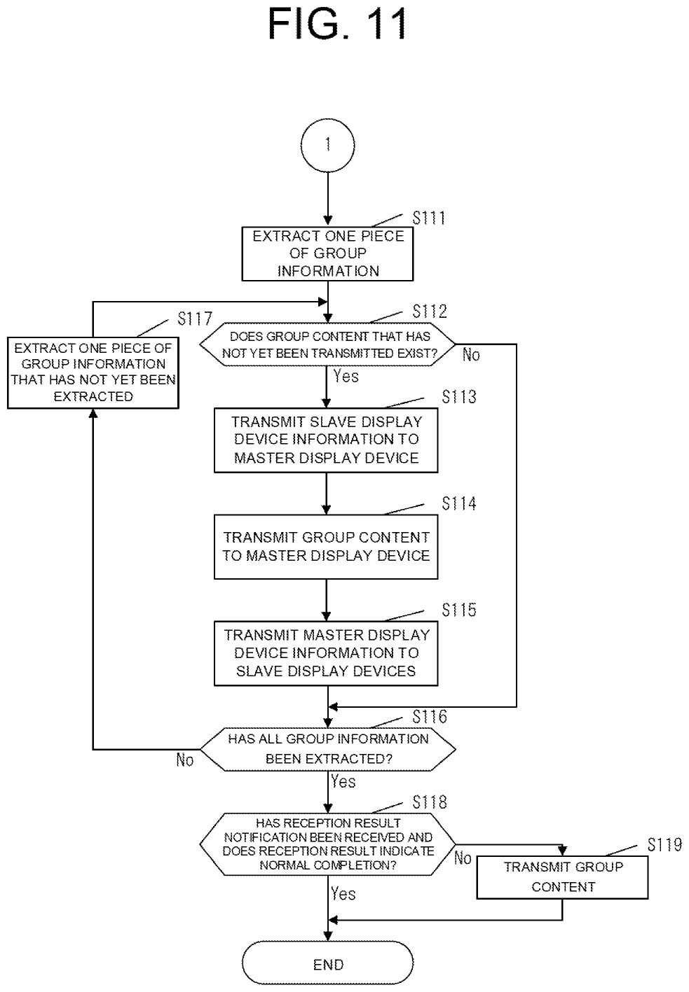

Next, the flow of main processing in the management server device will be described with reference to FIG. 10 and FIG. 11. First, the controller 100 stores content in the content storage area 128. The content is input by an administrator of the content transmission system 1 and the like. The controller 100 stores the input content in the content storage area 128 using a method which enables the content to be specified by information relating to the group, such as the group name (step S101).

Next, the controller 100 stores display device information in the display device information storage area 122 (step S102). The display device information is input by an administrator of the content transmission system 1 and the like based on the installation locations of the display devices 20 and the number of installed devices. Furthermore, the controller 100 stores the input display device information in the display device information storage area 122.

Next, the controller 100 performs grouping of the display devices 20 based on the display device information (step S103). The controller 100 performs grouping based on an attribute stored in the display device information, and forms groups from display devices 20 having the same attribute information. The type of attribute used to perform grouping may be determined by an administrator of the content transmission system 1 and the like, or may be determined by the management server device 10. Furthermore, the management server device 10 may perform grouping of the display devices 20 for each attribute among all of the attributes assigned to the display devices 20. The grouping may be performed using information other than an attribute, such as the installation location or the display device name. Moreover, grouping of the display devices may be performed by an administrator of the content transmission system 1 and the like.

Then, the controller 100 stores, for each display device 20, a grouping result from step S103, which indicates the group to which the display device 20 belongs, to the belonging group information storage area 124 as belonging group information (step S104). As a result, it is possible to specify the group to which each display device 20 belongs. Further, the controller 100 transmits the belonging group information to each of the display devices 20 (step S105).

Next, the controller 100 determines for each group the master display device 20a and the slave display device 20b (step S106). The master display device 20a and the slave display device 20b may be determined based on display device IDs and display device names input by an administrator of the content transmission system 1 and the like, or may be determined by the controller 100. As a result of the master display device 20a and the slave display device 20b being input by an administrator and the like, a specific display device 20 is capable of serving as the master display device 20a. If the determination is made by the controller 100, the effort associated with an administrator determining a master display device 20a for each group can be omitted.

Here, once the master display device 20a has been determined, the other device in the group may be made a slave display device 20b. Alternatively, each device may be classified as either a master display device 20a or a slave display device 20b.

If the determination is made by the controller 100, the controller 100 reads the belonging group information storage area 124 and randomly extracts a display device 20 from each group to serve as the master display device 20a. If information relating to the performance of the display devices 20 is stored in the display device information storage area 122, the display device 20 with the highest performance among the display devices belonging to the group may be made the master display device 20a based on the information relating to the performance and the like from the controller 200. Then, the controller 100 stores, for each group, group information including the information relating to the master display device 20a and the slave display device 20b determined in step S105 in the group information storage area 126 (step S107).

Next, moving to FIG. 11, the controller 100 extracts one piece of group information from the group information storage area 126 (step S111). Then, the controller 100 determines, based on the group information extracted in step S111, whether or not content exists among the group content stored in the content storage area 128 that has not yet been transmitted to the display devices 20 belonging to the group (step S112).

If content that has not yet been transmitted exists (step S112; Yes), the controller 100 transmits the slave display device information to the master display device 20a via the communication unit 110, and further transmits the group content to the master display device 20a (step S113→step S114). Furthermore, the controller 100 transmits the master display device information to the slave display device 20b via the communication unit 110 (step S115). If content that has not yet been transmitted does not exist, the flow proceeds to step S116 (step S112; No→step S116).

Then, the controller 100 determines whether or not all of the group information stored in the group information storage area 126 has been extracted (step S116). If all of the group information has not been extracted, the controller 100 extracts one piece of group information that has not yet been extracted, and returns to step S112 (step S116; No→step S117→step S112).

If all of the group information has been extracted, the controller 100 then receives a reception result notification transmitted from the slave display device 20b, and determines whether or not the reception result indicates a normal completion (step S118). If the reception result indicates an abnormal completion, or if the reception result notification is not received within a predetermined time, the controller 100 transmits the group content with respect to the slave display device 20b (step S118; No→step S119).

### 1.3.3 Flow of Main Processing in Display Device

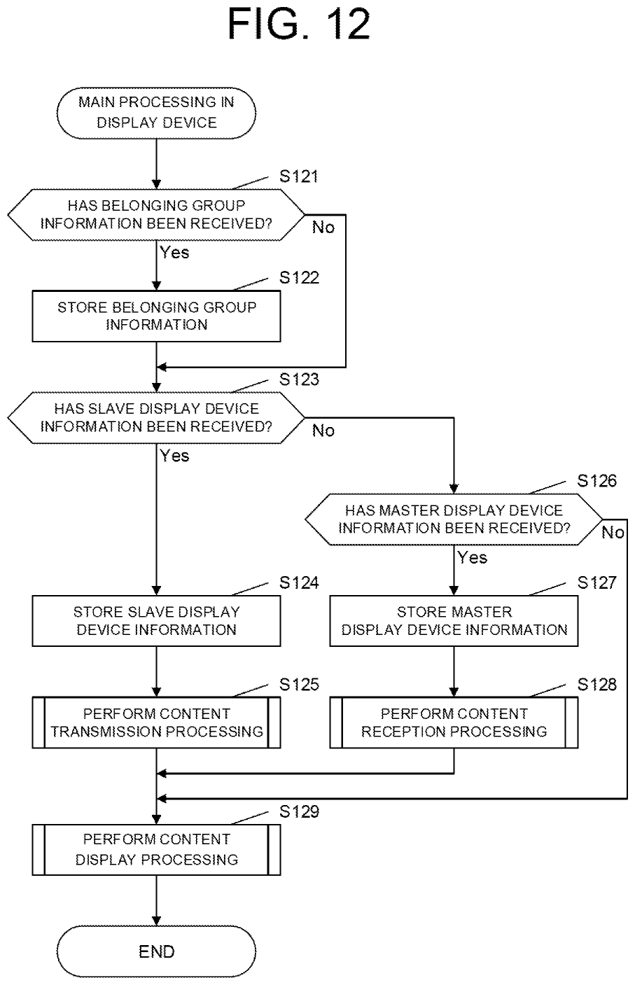

Main processing in the display device 20 will be described with reference to FIG. 12. First, when the controller 200 receives belonging group information from the management server device 10 via the communication unit 210, it stores the information as belonging group information 234 (step S121; Yes→step S122).

Next, the controller 200 determines whether or not slave display device information has been received from the management server device 10 via the communication unit 210 (step S123). If slave display device information has been received, the display device 20 indicates that it will function as the master display device 20a of the group. Therefore, the display device 20 stores the received slave display device information in the slave display device information storage area 240, and executes content transmission processing (step S123; Yes→step S124→step S125). The content transmission processing is processing that transmits group content received from the management server device 10 to the slave display device 20b belonging to the same group. The content transmission processing is described later.

If slave display device information is not received from the management server device 10, the controller 200 then determines whether or not master display device information has been received from the management server device 10 via the communication unit 210 (step S123; No→step S126). If master display device information has been received, the display device 20 indicates that it will function as the slave display device 20b of the group. Therefore, the display device 20 stores the received master display device information in the master display device information storage area 242, and executes content reception processing (step S126; Yes→step S127→step S128). The content reception processing is processing that receives group content from the master display device 20a. The content reception processing is described later.

Next, the display device 20 executes content display processing that displays the content stored in the content storage area 236 (step S129). The content display processing is described later.

### 1.3.4 Flow of Content Transmission Processing

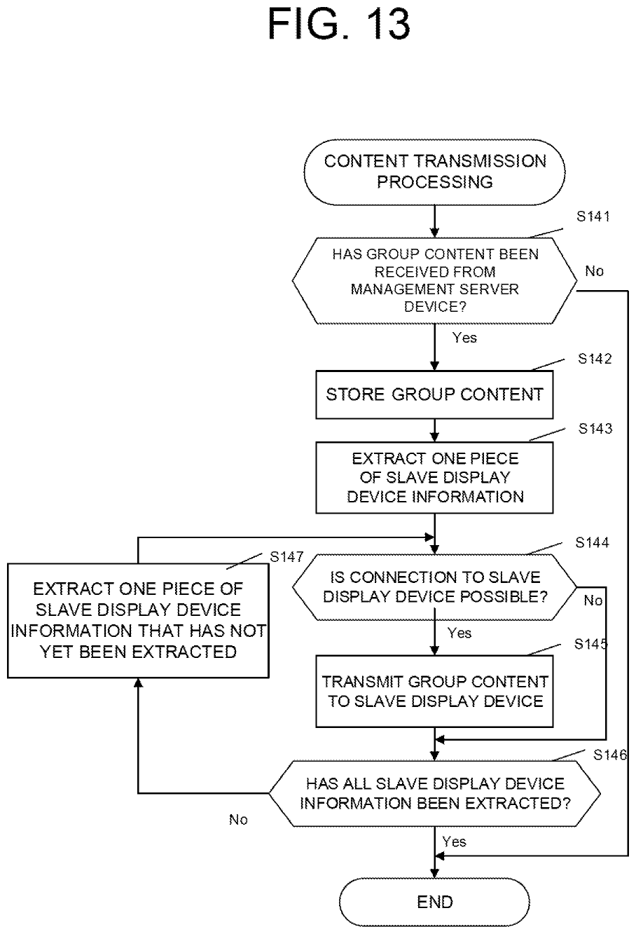

The content transmission processing will be described with reference to FIG. 13. First, the controller 200 determines whether or not group content has been received from the management server device 10 via the communication unit 210, and stores the received group content in the content storage area 236 if group content has been received (step S141; Yes→step S142). At this time, the controller 200 stores the received group content in the content storage area 236 such that the content can be specified by group information such as the group name.

Next, the controller 200 extracts one piece of slave display device information from the slave display device information storage area 240, and uses the IP address and the connection authentication information included in the slave display device information to determine whether connection to the slave display device 20b is possible (step S143→step S144). If connection is possible, the controller 200 transmits group content to the connected slave display device 20b (step S144; Yes→step S145).

Here, in order to determine whether or not the master display device 20a and the slave display device 20b can be connected, the slave display device 20b may notify the master display device 20a of the result of authentication based on the connection authentication information transmitted from the master display device 20a. In this case, if the master display device 20a receives a notification from the slave display device 20b indicating that authentication according to the connection authentication information has been successful, the controller 200 determines that connection to the slave display device 20b is possible. On the other hand, if a notification is received from the slave display device 20b indicating that authentication according to the connection authentication information has been unsuccessful, the controller 200 determines that connection to the slave display device 20b is not possible. It may be determined that connection to the slave display device 20b is not possible if the display device specified by an IP address stored in the slave display device information does not exist within the network NW. Furthermore, the controller 200 may determine that connection to the slave display device 20b is not possible if a notification indicating whether or not authentication has been completed normally is not received after a predetermined time has elapsed.

After completing the transmission of group content to the slave display device 20b, the controller 200 determines whether or not all of the slave display device information stored in the slave display device information storage area 240 has been extracted (step S146). If all of the slave display device information stored in the slave display device information storage area 240 has been extracted, the content transmission processing ends (step S146; Yes). If all of the slave display device information stored in the slave display device information storage area 240 has not been extracted, one piece of slave display device information that has not yet been extracted is extracted, and the flow returns to step S144 (step S146; No→step S147→step S144).

### 1.3.5 Flow of Content Reception Processing

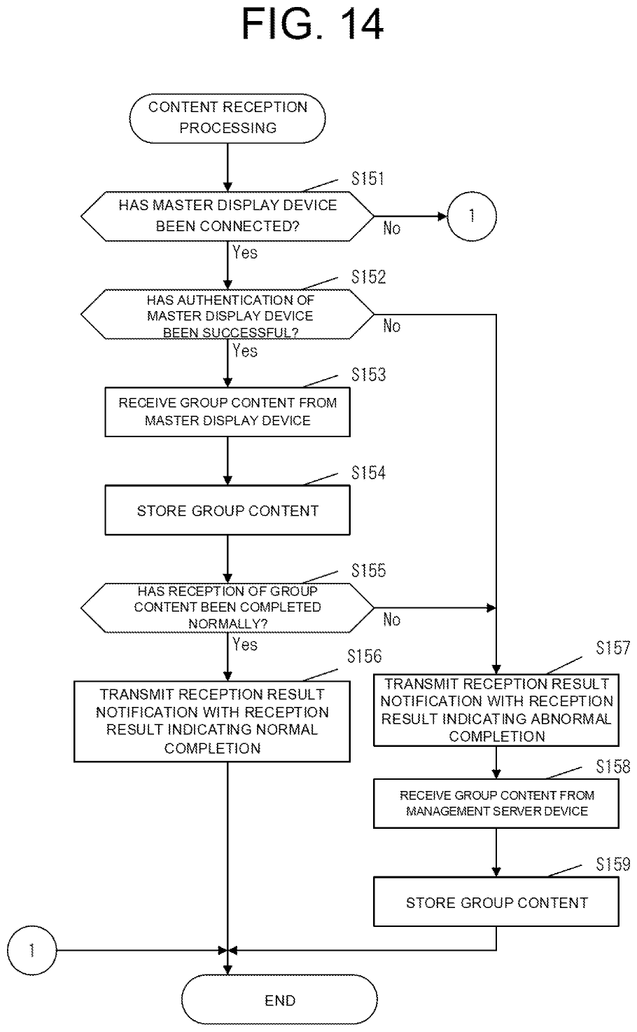

The content reception processing will be described with reference to FIG. 14. First, the controller 200 determines, via the communication unit 210, whether or not the master display device 20a is connected (step S151). The connection by the master display device 20a is performed as a result of the master display device 20a making a connection request with respect to the slave display device 20b, and transmitting a password which represents the connection authentication information.

Next, the controller 200 performs authentication of the master display device 20a, which is the connection source, based on the connection authentication information. In the present embodiment, because a password is transmitted from the master display device 20a as the connection authentication information, the controller 200 determines whether or not the received password matches the password stored as the connection authentication information 232. If the password received from the master display device 20a matches the password stored as the connection authentication information 232, the master display device 20a, which is the connection source in step S151, is determined to have been successfully authenticated as a legitimate master display device 20a. On the other hand, if the password received from the master display device 20a does not match the password stored as the connection authentication information 232, the master display device 20a, which is the connection source in step S151, is determined to have failed authentication as a legitimate master display device 20a. Then, the controller 200 notifies the authentication result to the master display device 20a, which is the connection source, via the communication unit 210.

In step S152, if the master display device 20a has been successfully authenticated, the group content transmitted from the master display device 20a is then received (step S152; Yes→step S153). Then, the controller 200 stores the received group content in the content storage area 236 (step S154). At this time, the controller 200 stores the received group content in the content storage area 236 such that the content is associated with group information such as the group name.

Next, the controller 200 determines whether or not reception of the group content has been completed normally (step S155). If reception of the group content has been completed normally, the controller 200 transmits a reception result notification indicating a reception result of “normal completion”to the management server device 10 via the communication unit 210 (step S155; Yes→step S156). Then, the content reception processing ends.

If the master display device 20a has failed authentication in step S152 (step S152; No), or reception of the group content has not been completed normally in step S155 (step S155; No), the flow proceeds to step S157.

In step S157, the controller 200 transmits a reception result notification indicating a reception result of “abnormal completion” to the management server device 10 via the communication unit 210 (step S157). Further, when the group content transmitted from the management server device 10 is received, the received group content is stored in the content storage area 236 (step S158→step S159). At this time, the received group content is stored in the content storage area 236 such that the content can be specified by group information such as the group name.

### 1.3.6 Flow of Content Display Processing

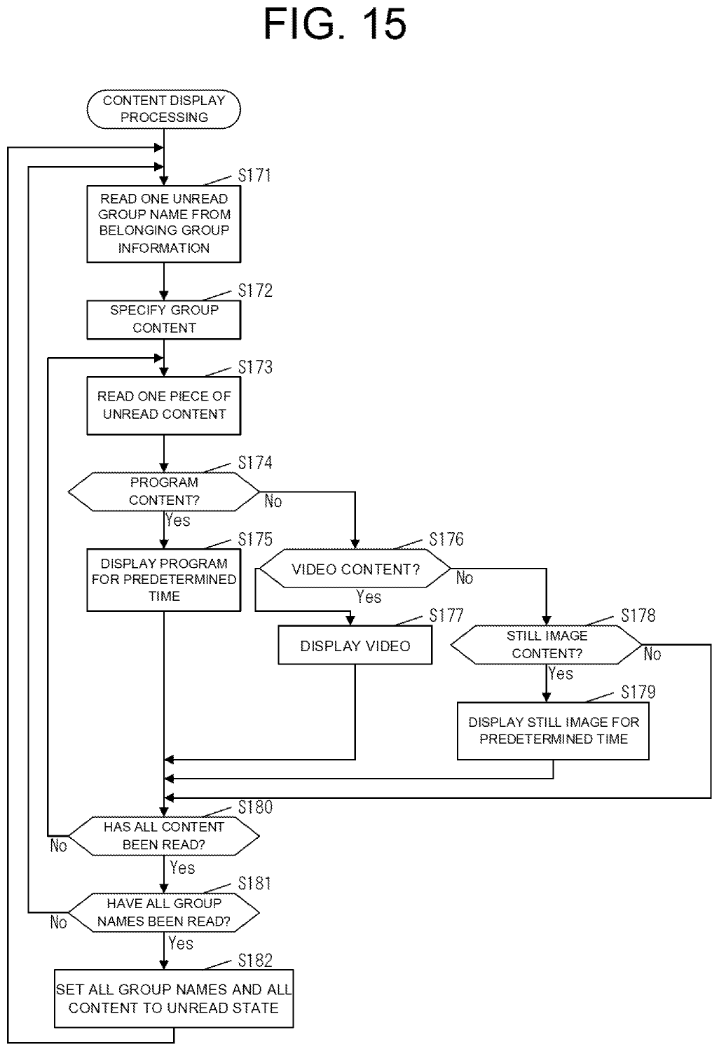

The flow of content display processing will be described with reference to FIG. 15. The content display processing of the present embodiment is processing that successively reads and displays the group content for each group.

First, the controller 200 reads one group name from among the group names stored in the belonging group information 234 that have not been read so far (step S171). Then, the controller 200 specifies, based on the group name read in step S171, the content corresponding to the group name from among the content stored in the content storage area 236, that is to say, the group content (step S172). For example, in the present embodiment, because the group name is stored as the belonging group information 234, one unread group name is read, and then the group content is specified from among the content stored in the content storage area 236 based on the group name.

Next, the controller 200 reads one piece of content from among the group content that has not been read so far (step S173). At this time, if the read content is program content, the program content is displayed on the display unit 220 for a predetermined period (step S174; Yes→step S175). If the read content is video content, the video content is displayed on the display unit 220 (step S174; No→step S176; Yes→step S177). The video content may be displayed on the display unit 220 for the length of the video. If the read content is still image content, the still image content is displayed on the display unit 220 for a predetermined period (step S176; No→step S178; Yes→step S179). In all cases, the flow proceeds to step S180 after the display period elapses.

It may be determined in advance how long program content and still image content is displayed. When program content is displayed, displaying of the content may be completed after playback of all of the videos displayed within the program content has ended.

If the content read in step S173 is not program content, video content, or still image content, that is to say, if the content cannot be displayed on the display unit 220, the flow proceeds to step S180 (step S178; No→step S180).

Next, the controller 200 determines whether or not all of the content has been read from the group content (step S180). If all of the content has been read, the flow proceeds to step S181 (step S180; Yes→step S181). If not all of the content has been read, the flow returns to step S173 (step S180; No→step S173).

Then, the controller 200 determines whether or not all of the group names stored in the belonging group information 234 have been read (step S181). If all of the group names have been read, all of the group names and all of the content that have been read so far are set to an unread state (step S181; Yes→step S182). That is to say, initialization is performed. Then, the flow returns to step S171. In such a manner, it becomes possible to display the group content stored in the content storage area 236 for each group on the display unit 220 again. As a result of repeating the content display processing, the content stored in the content storage area 236 is repeatedly displayed on the display unit 220.

In step S181, if not all of the group names have been read, the flow returns to step S171 (step S181; No→step S171). In such a manner, the group content for those groups that have not been read so far can be displayed on the display unit 220.

### 1.4 Operation Example

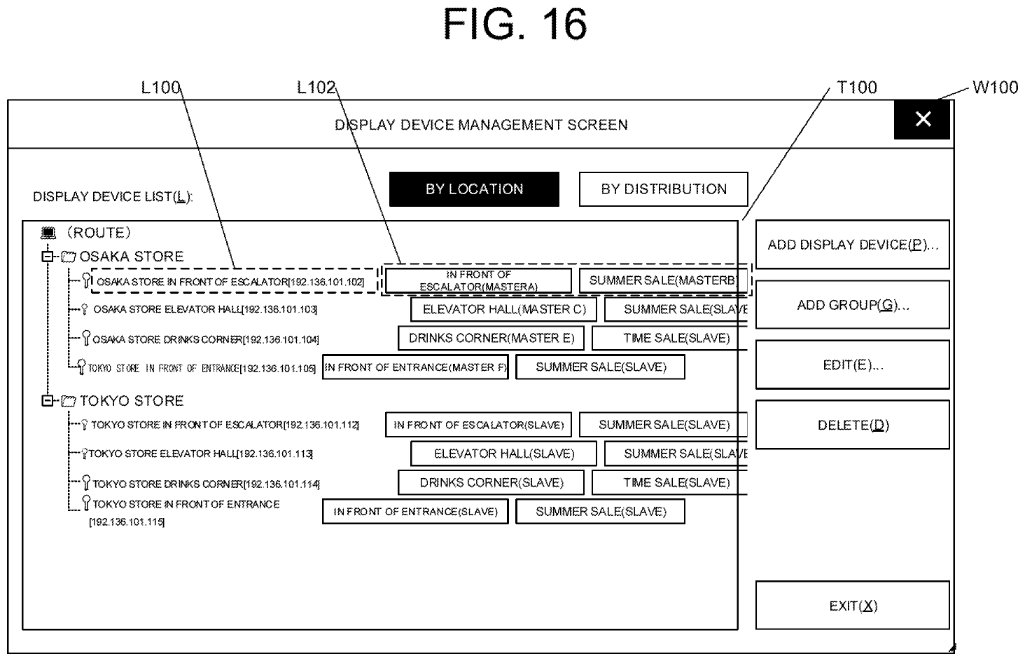

An operation example of the present embodiment will be described with reference to the drawings. FIG. 16 is an example of a management screen of the display device 20 provided by the management server device 10. FIG. 16 is an example of a display screen W100 including a tree T100 that represents the display devices 20 managed by the management server device 10 in tree form.

In the tree T100, display devices 20 are displayed classified based on information relating to the installation location included in the display device information (display by location). Furthermore, the nodes of the tree T100 include a label L100 which displays the display device name and IP address of the display device 20, and a label L102 which displays the group name to which the display device 20 belongs, and whether the display device 20 is a master display device or a slave display device. In such a manner, the display devices 20 can be managed based on the locations in which the display devices 20 are installed.

As shown in FIG. 16, “Osaka store, in front of escalator” represents the master display device 20a of the “in front of escalator” group, as well as the master display device 20a of the “summer sale” group. In this manner, a single display device 20 may sometimes serve as the master display device 20a of a plurality of groups.

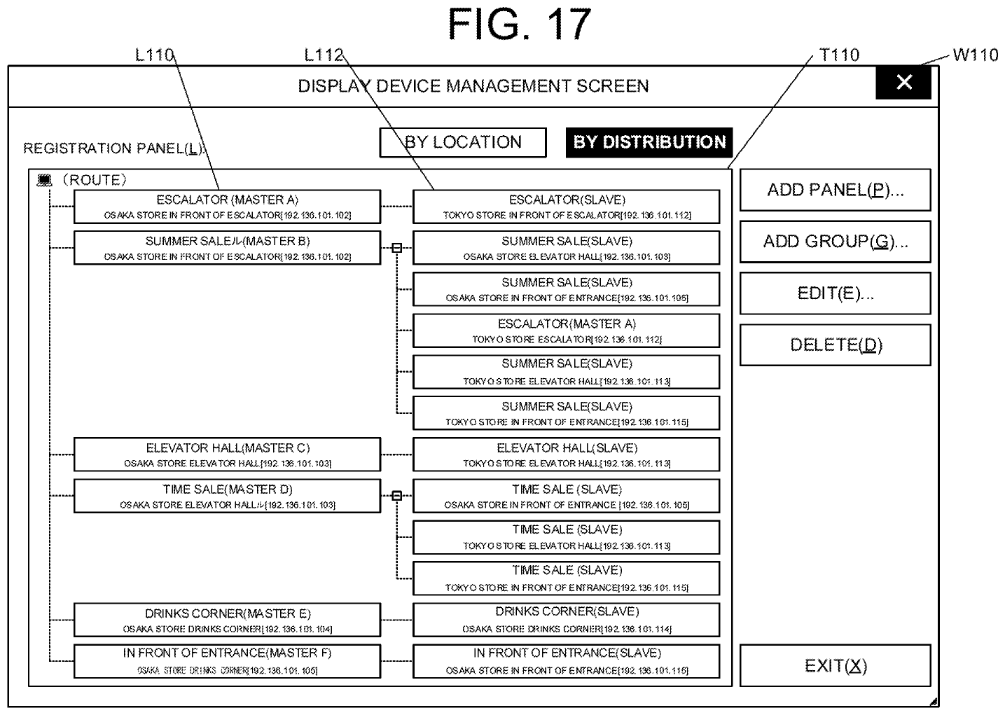

FIG. 17 is an example of a display screen W110 including the tree T100) shown in FIG. 16, and a tree T110 displayed by group. The tree T110 displays the master display device 20a and slave display devices 20b for each group. For example, the label L110 displays information relating to the “Osaka store, in front of escalator” display device 20, which is the master display device 20a of the “in front of escalator” group. Furthermore, the label L112 displays information relating to the “Tokyo store, in front of escalator” display device 20, which is a slave display device 20b of the “in front of escalator” group. In the tree T110, the label L110 and the label L112 are displayed so as to indicate a parent-child relationship. Therefore, an administrator of the content transmission system 1 and the like is capable of confirming the group to which a display device 20 belongs, and the master display device 20a and slave display devices 20b for each group by viewing the display screen W110.

The display screen W100 and the display screen W110 may be switched. Furthermore, in the management server device 10, the group to which a display device 20 belongs or the display device 20 that serves as the master display device 20a may be changed via time display screen W100 and the display screen W110 by means of an administrator of the content transmission system 1 and the like.

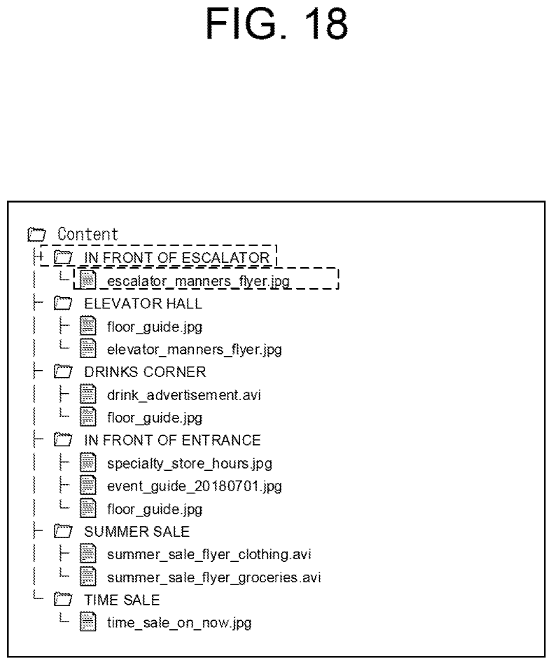

FIG. 18 is a diagram showing an example of storage in the content storage area 128. As shown in FIG. 18, when the “content” folder serves a content storage area, the folder names are set to the group names, and further, the content is stored in subfolders. In such a manner, based on the group name, which is group information, it becomes possible to specify the content associated with information relating to the group.

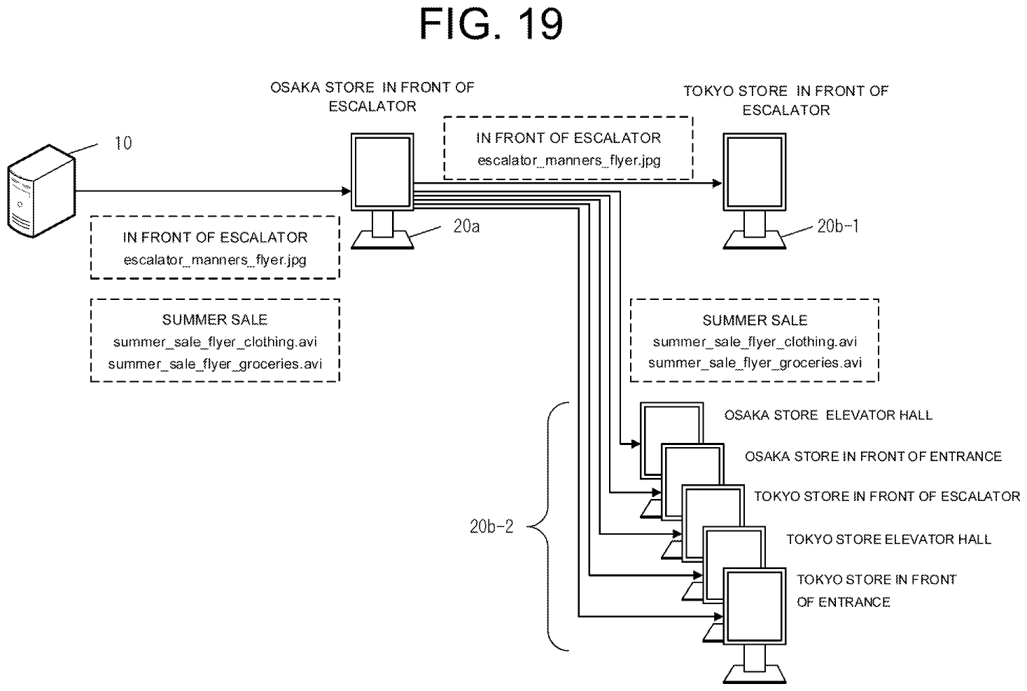

FIG. 19 is a diagram showing a specific example of content transmission. Here, a case is described where the management server device 10 transmits content to the “in front of escalator” group and the “summer sale” group. It is assumed that the group information of the display devices 20 follows the example shown in FIG. 3 and FIG. 4, and that the content shown in FIG. 18 is stored in the content storage area 128.

First, the management server device 10 transmits the group content (escalator_manners_flyer.jpg) of the “in front of escalator” group to the “Osaka store, in front of escalator” display device 20, which is the master display device 20a of the “in front of escalator” group. After receiving the group content of the “in front of escalator” group, the “Osaka store, in front of escalator” display device 20 transmits the group content of the “in front of escalator” group to the “Tokyo store, in front of escalator” display device 20 (display device 20b-1), which is a slave display device.

Similarly, the management server device 10 transmits the group content (summer_sale_flyer_clothing.avi, summer_sale_flyer_groceries.avi) of the “summer sale” group to the “Osaka store, in front of escalator” display device 20, which is the master display device 20a of the “summer sale” group. As already described, a single display device 20 may sometimes serve as the master display device 20a of a plurality of groups. As shown in FIG. 19, “Osaka store, in front of escalator” represents the master display device 20a of the “in front of escalator” group, as well as the master display device 20a of the “summer sale” group.

Then, the “Osaka store, in front of escalator” display device 20, which has received the group content of the “summer sale” group, transmits the group content of “summer sale” group to the five display devices 20 (display devices 20b-2) serving as slave display devices.

In this manner, the group content of the “in front of escalator” group is transmitted to two display devices 20, and the group content of the “summer sale” group is transmitted to six display devices 20. However, the management server device 10 only needs to transmit the group content of the “in front of escalator” group and the group content of the “summer sale” group to the “Osaka store, in front of escalator” display device 20. Thereafter, the group content is transmitted to the slave display devices 20b by each master display device 20a.

According to the present embodiment, the management server device 10 may transmit the content to the master display device 20a determined for each group without transmitting the content to all of the display devices 20 managed by the management server device 10. Therefore, the required processing of the management server device 10 can be reduced, and the time during which the management server device 10 is in processing can be reduced.

Further, in each group, because the master display device 20a transmits the content to the slave display devices 20b, the content transmission processing becomes distributed. Therefore, it becomes possible to reduce the time taken to perform content transmission.

In addition, when the display devices 20 are installed in a location having the same facilities, such as in chain stores where the in-store configuration is the same for each store, the content can be managed for each installation location. For example, if the display devices 20 are installed in front of copy machines, then the grouping of the display devices 20 can be performed using a configuration in which, for example, the display device 20 installed in front of a copy machine in the Osaka store serves as the master display device 20a, and the display devices 20 installed in front of a copy machine in other stores serve as the slave display devices 20b. Therefore, it becomes possible to transmit the same content to the group. Moreover, even in a case such as a shopping mall where the tenant is different for each shopping mall, it is possible to perform grouping of the display devices 20 installed to a facility inside the shopping mall such as in front of an elevator, or the display devices 20 installed in front of a common product such as “in front of neckties”. In this manner, even if the installation stores (locations) are different, the display devices 20 can be grouped according to the installation environment.

Further, even if the environment in which the display devices 20 are installed is similar, if the orientation or resolution of the display unit of the display devices 20 is different, an attribute such as the orientation or resolution of the display unit of the display device 20 can be assigned such that display devices 20 assigned with identical or similar attributes can be grouped at the attribute level. In this case, the display device 20 can be grouped into groups such as “in front of elevator (vertical)” and “in front of elevator (horizontal)”, and content can be transmitted which is appropriate for the display devices 20 belonging to each group. In this manner, improvements in convenience in terms of the operation of the content transmission system can be expected.

The content of the processing in the above description may be changed to an extent that does not cause inconsistencies. For example, the grouping information may be information that includes information relating to the master display device 20a and the slave display device 20b belonging to the same group. The master display device 20a is capable of determining, from the display device ID and the IP address assigned to its own device, that the information within the grouping information other than that of its own device represents the information of the slave display device 20b. Therefore, the content ca be transmitted to the slave display device 20b based on the information other than that of its own device.

Furthermore, in the content display processing, the group content stored in the content storage area 236 may be randomly displayed without using the belonging group information 234. In this case, the management server device 10 is capable of omitting the processing that transmits belonging group information to the display devices 20. Moreover, the display devices 20 are no longer required to extract group information that has not yet been read, or determine whether all of the group information has been read.

### 2. Second Embodiment

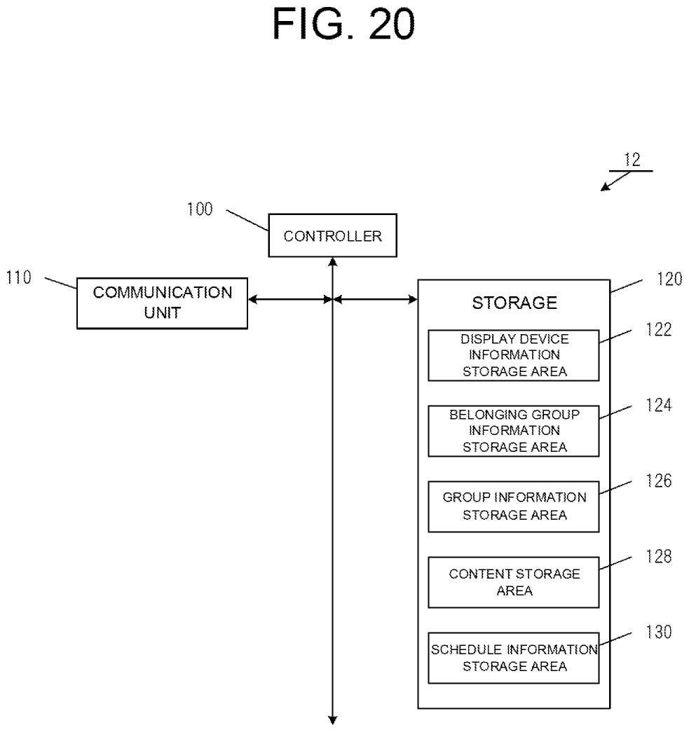

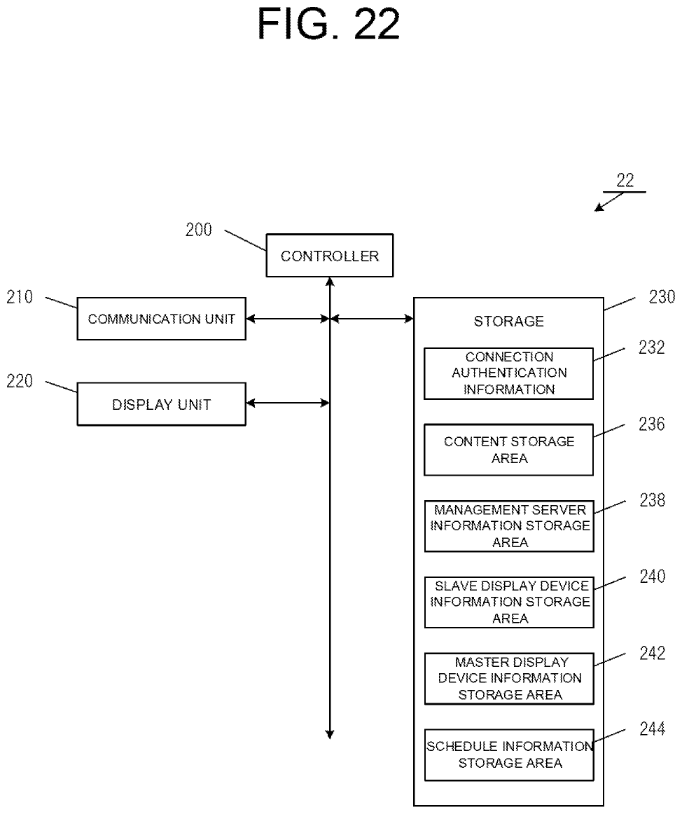

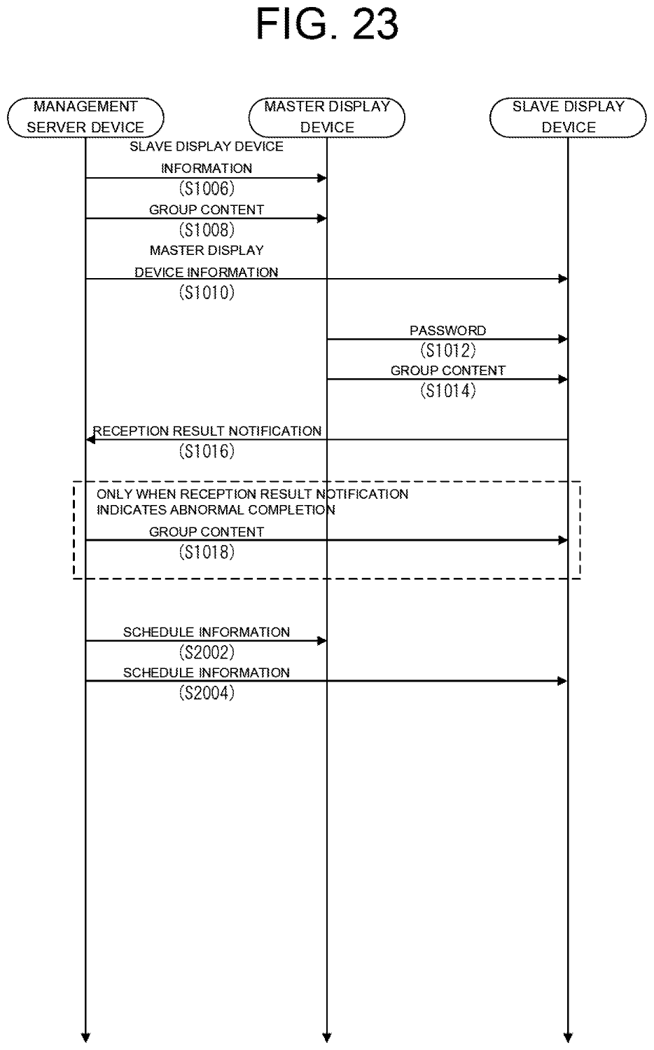

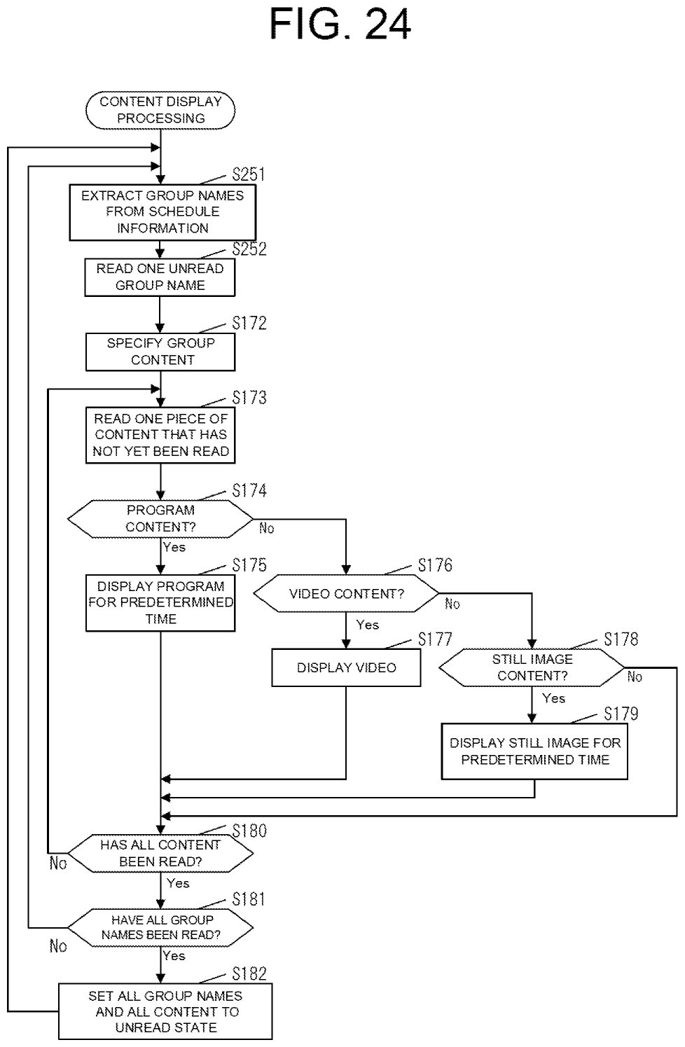

Next, a second embodiment will be described. The second embodiment is an embodiment in which, in addition to the features of the first embodiment, transmission of schedule information is performed. The present embodiment replaces FIG. 2 of the first embodiment with FIG. 20, FIG. 6 with FIG. 22, FIG. 9 with FIG. 23, and FIG. 15 with FIG. 24. In addition, the same reference numerals are given to the same functional units and processing, and the description will be omitted.

### 2.1 Functional Configuration

### 2.1.1 Functional Configuration of Management Server Device

The functional configuration of a management sever device 12 of the present embodiment will be described with reference to FIG. 20. The management server device 12 differs from the management server device 10 in that the storage 120 further secures a schedule information storage area 130.

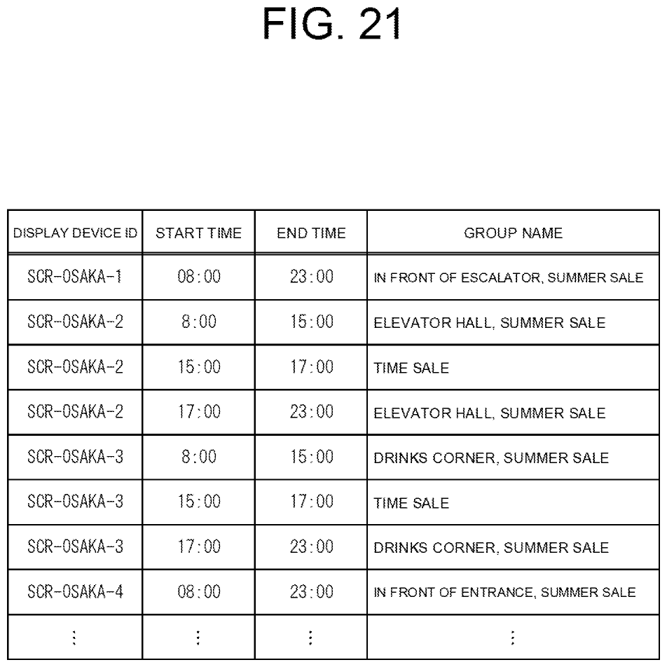

The schedule information storage area 130 is an area that stores schedule information, which is information relating to a schedule for the content displayed by the display devices 20. The schedule information stored in advance by an administrator of the content transmission system 1 and the like. FIG. 21 is a diagram showing schedule information according to the present embodiment. As shown in FIG. 21, the slave information stores a display device ID (for example, “SCR-OSAKA-2”) for specifying a display device 20, a start time (for example, “08:00”) which is the time at which content display starts, an end time (for example, “23:00”) which is the time at which the content display ends, and a group name (for example, “in front of escalator, summer sale”) for specifying the content to be displayed.

Furthermore, schedule information is stored for each display device 20. In such a manner, it becomes possible to change the timing in which content is displayed among the display devices 20 to which the same content is transmitted.

### 2.1.2 Functional Configuration of Display Device

The functional configuration of a display device 22 of the present embodiment will be described with reference to FIG. 22. The display device 22 differs from the display device 20 in that the storage 230 further secures a schedule information storage area 244 and does not store the belonging group information 234.

The schedule information storage area 244 is an area that stores schedule information, which is information relating to a schedule for the content displayed by the display devices 20. The schedule information may have the same configuration as the schedule information, or may have any configuration having a format in which the display start time and display end time of the content, and the content to be displayed can be specified.

### 2.2 Processing Flow

The data transmitted and received in the content transmission system 1 of the present embodiment will be described with reference to FIG. 23. The present embodiment is different in that, in addition to the transmission and reception of data shown in FIG. 9, the management server device 10 transmits group information to the display devices 20. All of the group information stored in the group information storage area 126 may be transmitted as group information transmitted by the management server device 10 to the display devices 20. Alternatively, transmission from the group information storage area 126 may be limited to the group information corresponding to the display device 20 at the transmission destination. Furthermore, the timing in which the group information transmitted may be before the transmission of content from the management server device 10 to the display devices 20. The display devices 20 store the group information received from the management server device 10 in the schedule information storage area 244.

In the present embodiment, the display devices 20 determine the content to be displayed based on the schedule information rather than the belonging group information. Therefore, the processing that transmits belonging group information from the management server device 10 to the display devices 20 is omitted.

The content display processing of the present embodiment will be described with reference to FIG. 24. In the present embodiment, the content is displayed based on the schedule information. First, the controller 200 reads from the schedule information storage area 244 schedule information in which the current time falls between the start time and the end time, and extracts the group names stored in the schedule information (step S251).

Next, the controller 200 reads one group name that has not yet been read among the group names read in step S251 (step S252). Then, the group content is displayed based on the group name read in step S252 by executing step S172 to step S182.

According to the present embodiment, the content is not repeatedly displayed, and it is possible to control the displayed content according to the time period.

Furthermore, even if the schedule is not determined, the group content can be transmitted in advance as long as the display devices 20 are grouped in advance. Moreover, if the amount of content in a specific group content is large, or if the data volume of the content is large, it is possible to transmit only the group content of that specific group before the schedule is determined. In this manner, a flexible content transmission operation is possible, wherein the content is transmitted in advance from the management server device 10 to the display devices 20, and the schedule is transmitted thereafter.

### 3. Third Embodiment

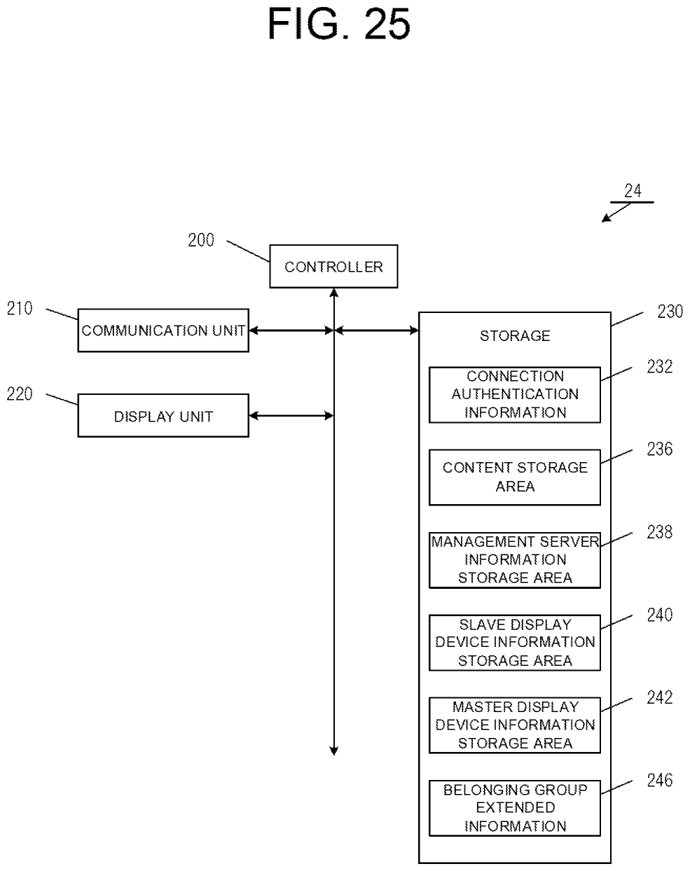

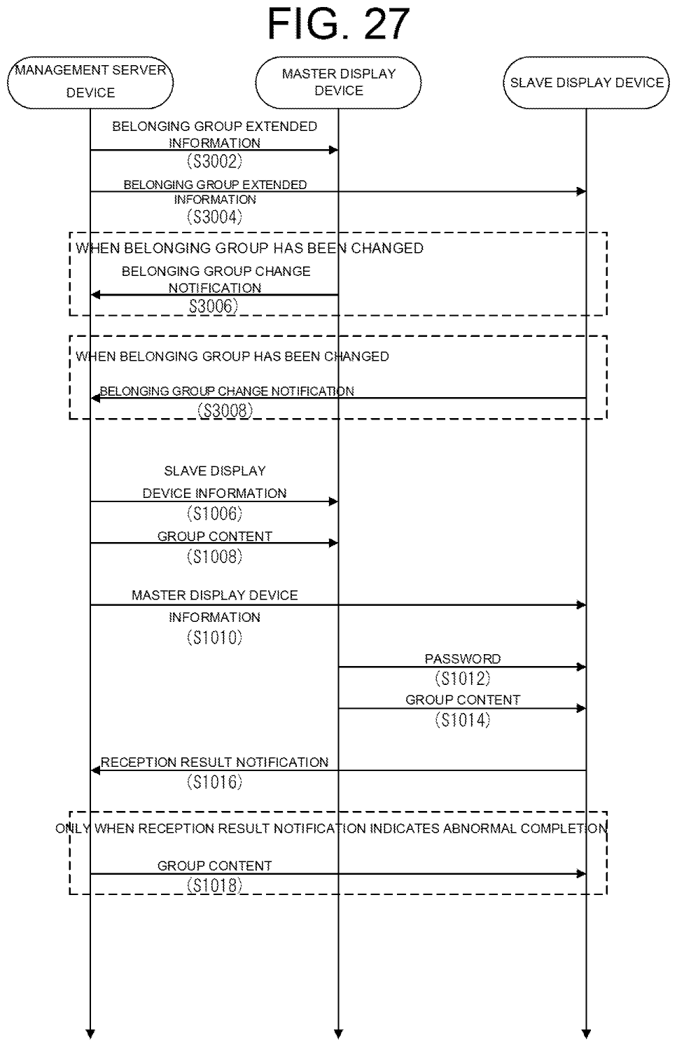

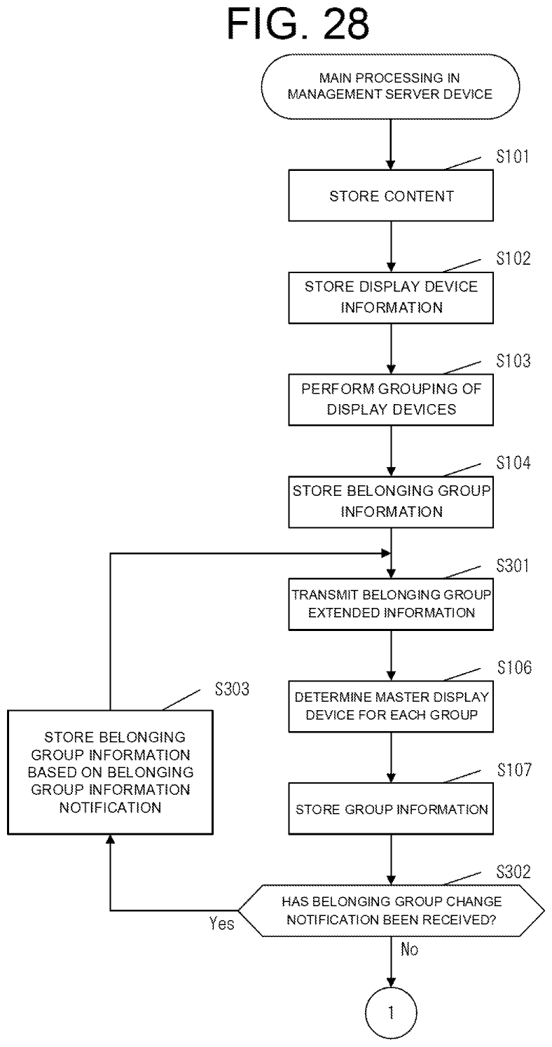

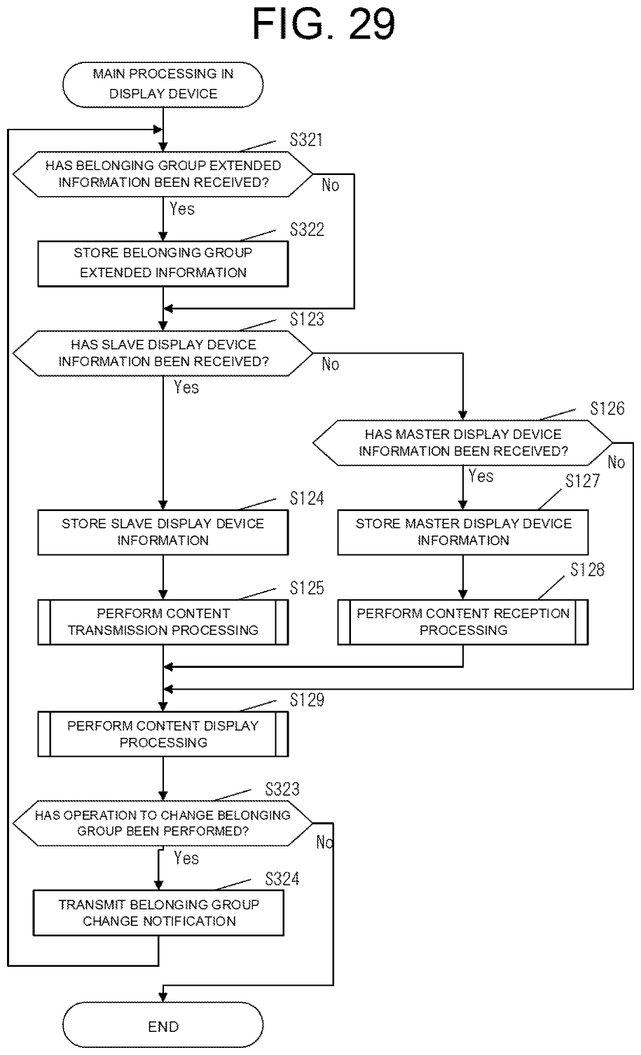

The third embodiment differs from the first embodiment in that a belonging group can be changed by the display device 20. The present embodiment replaces FIG. 6 of the first embodiment with FIG. 25, FIG. 9 with FIG. 27, FIG. 10 with FIG. 28, and FIG. 12 with FIG. 29. In addition, the same reference numerals are given to the same functional units and processing, and the description will be omitted.

### 3.1 Functional Configuration of Display Device

The functional configuration of a display device 24 of the present embodiment will be described with reference to FIG. 25. The display device 24 differs from the display device 20 in that the storage 230 stores belonging group extended information 246 instead of the belonging group information 234.

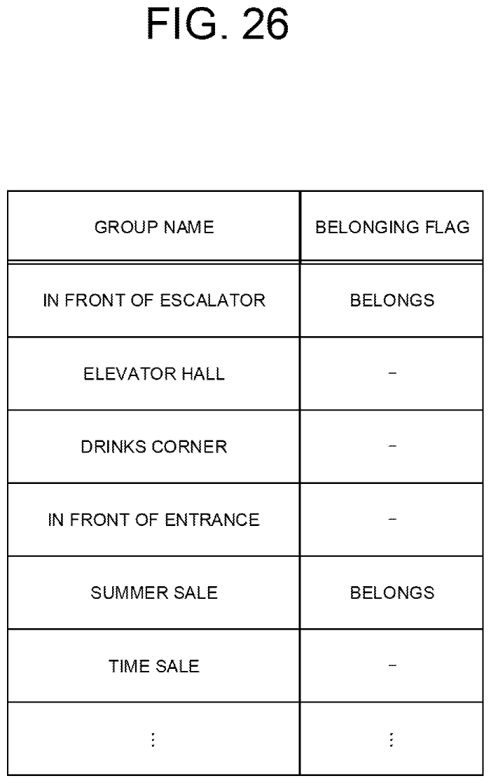

The belonging group extended information 246 is information which stores the group to which the display device 20 belongs among all of the groups defined based on the group information stored in the management server device 10. FIG. 26 is a diagram showing the belonging group extended information 246 in the present embodiment. As shown in FIG. 26, the belonging group extended information 246 stores a group name (for example, “in front of escalator”) for specifying a group, and a belonging flag (for example, “belongs”) indicating whether or not the display device 20 belongs to the group. The belonging flag does not store information for groups to which the display device 20 does not belong.

### 3.2 Processing Flow

The processing flow will be described with reference to FIG. 27. First, the management server device 10 transmits belonging group extended information to the master display device 20a and the slave display device 20b (S3002→S3004). Here, among the information included in the belonging group extended information, the group names of all of the groups may be extracted based on the group information stored in the group information storage area 126. Furthermore, among the belonging group information stored in the belonging group information storage area 124, the belonging flag may be determined based on the group name associated with the display device 20 at the transmission destination.

Furthermore, if the group to which a display device 20 is changed, the display device 20 transmits a belonging group change notification to the management server device 10 (S3006→S3008). A belonging group change notification is information indicating which group the display device 20 newly belongs to, and which group it has left. As the belonging group change notification, the display device 20 may transmit to the management server device 10 the changed belonging group extended information 246, or only the group name of the group the display device 20 will belong to after the change.

FIG. 27 depicts a drawing in which the belonging group extended information 246 is transmitted to both the master display device 20a and the slave display device 20b. However, the master display device 20a and the slave display device 20b are not yet determined at this time. Therefore, the management server device 10 transmits the belonging group extended information 246 to all of the display devices 20 managed by the management server device 10, irrespective of whether they serve as a master display device 20a or a slave display device 20b.

Furthermore, FIG. 27 depicts transmission of the belonging group change notification before transmission of the group content. However, the belonging group change notification may be transmitted after transmission of the group content. That is to say, a display device 20 may change the group to which it belongs at an arbitrary timing.

The main processing in the management server device 10 of the present embodiment will be described with reference to FIG. 28. After storing the belonging group information, the controller 100 then transmits the belonging group extended information 246 to the display devices 20 (step S301).

Furthermore, after the management server device 10 receives a belonging group change notification from a display device 20, it stores the belonging group information based on the received belonging group change notification and the flow returns to step S301 (step S302; Yes→step S303→step S301). That is to say, the group to which the display device 20 of the belonging group change notification belongs is changed based on the belonging group change notification, and the belonging group is updated after storage as belonging group information. Further, by executing the processing after step S301 based on the updated belonging group information, the master display device 20a is determined in step S106 based on the belonging group information relating to the group to which the display device 20 newly belongs. Moreover, because the display device 20 newly belonging to the group is in a state where the content of the group has not been transmitted, the determination in step S112 is “Yes”. Therefore, the controller 100 is capable of transmitting the group content of the new belonging group to the display device 20 by executing step S113 to step S119.

The main processing in the display device 24 will be described with reference to FIG. 29. First, the controller 200 determines whether or not belonging group extended information has been received from the management server device 10 via the communication unit 210 (step S321). If belonging group extended information has been received from the management server device 10, the received belonging group extended information is stored as the belonging group extended information 246 (step S321; Yes→step S322).

Furthermore, if an operation to change the belonging group is performed by an administrator of the content transmission system 1 and the like, the controller 200 transmits a belonging group change notification relating to the changed belonging group to the management server device 10 via the communication unit 210 (step S323; Yes→step S324).

### 3.3 Operation Example

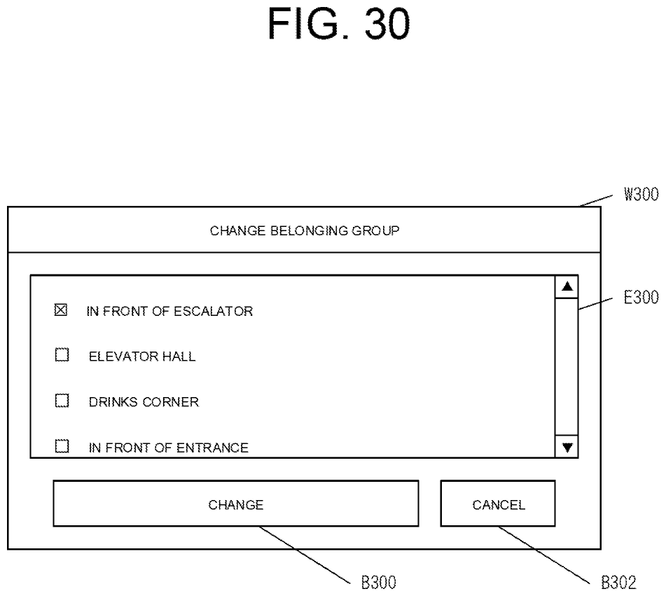

An example of a screen for changing a belonging group in the present embodiment is shown in FIG. 30. FIG. 30 is an example of a display screen W300, which is a belonging group changing screen displayed on a display device 20. This screen is a screen displayed by an administrator of the content transmission system 1 and the like. Furthermore, the display screen W300 includes a list area E300 for selecting a belonging group, a change button B300 for applying a change to the belonging group, and a cancel button B302 for closing the display screen W300 without changing the belonging group.

The list area E300 displays the names of the groups to which the display device 20 can belong, and shows the names of the groups to which the display device 20 currently belongs by way of a checkbox alongside the group name. The display device 20 is capable of displaying the list area E300 by displaying the group names stored in the belonging group extended information 246, and placing a check in the checkboxes displayed alongside the group names in which the belonging flag is set to “belongs”.

After the checkboxes are changed by an operation by an administrator of the content transmission system 1 and the like, the display device 20 transmits a belonging group change notification to the management server device 10 based on the state of the list area E300 if the change button B300 is selected. If the display device 20 belongs to a new group as a result of changing the belonging group, group content is transmitted to the display device 20 directly from the management server device 10 or from the master display device 20a of the new belonging group.

According to the present embodiment, if a change in the displayed content is desired due to a change in the installation location of the display device 20 and the like, it is possible to change the belonging group by operation of the display device 20. Because the group to which the display device 20 belongs can be changed without changing the belonging group information storage area 124 stored in the management server device 10, improvements in convenience can be expected.

In a case where the second embodiment and the third embodiment are combined such that the display device 20 displays content according to the schedule information, it is possible that the schedule information used up to that point can no longer be used if the group to which the display device 20 belongs is changed. For example, suppose that content is being displayed according to a schedule in which the group content of the “for escalator” group and the group content of the “summer sale” group is being repeatedly shown, and then the display device 20 leaves the “for escalator” group and joins the “in front of entrance” group. In this case, the group content of the “for escalator” group is no longer updated for that display device 20. Therefore, problems can occur such as the group content of the old “for escalator” group continuing to be displayed, or there no longer being any content to display as a result of the group content of the “for escalator” group being removed. Accordingly, when a belonging group change notification is received from the display device 20, the management server device 10 may generate schedule information based on the new belonging group of the display device 20 at the transmission source, and transmit the generated schedule information to the display device 20 at the transmission source. Then, as a result of displaying content based on the new schedule information, the display device 20 is capable of displaying content based on appropriate schedule information even when the belonging group is changed.

### 4. Fourth Embodiment

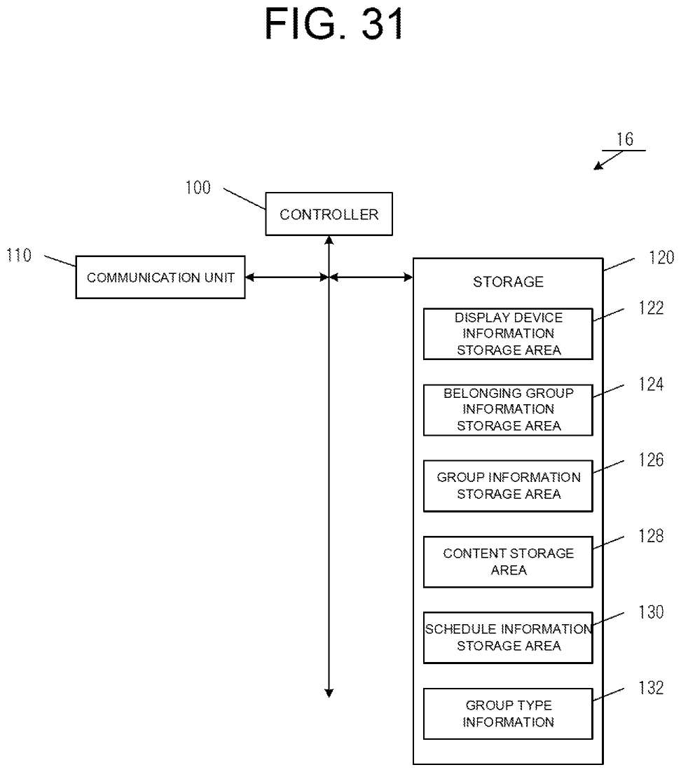

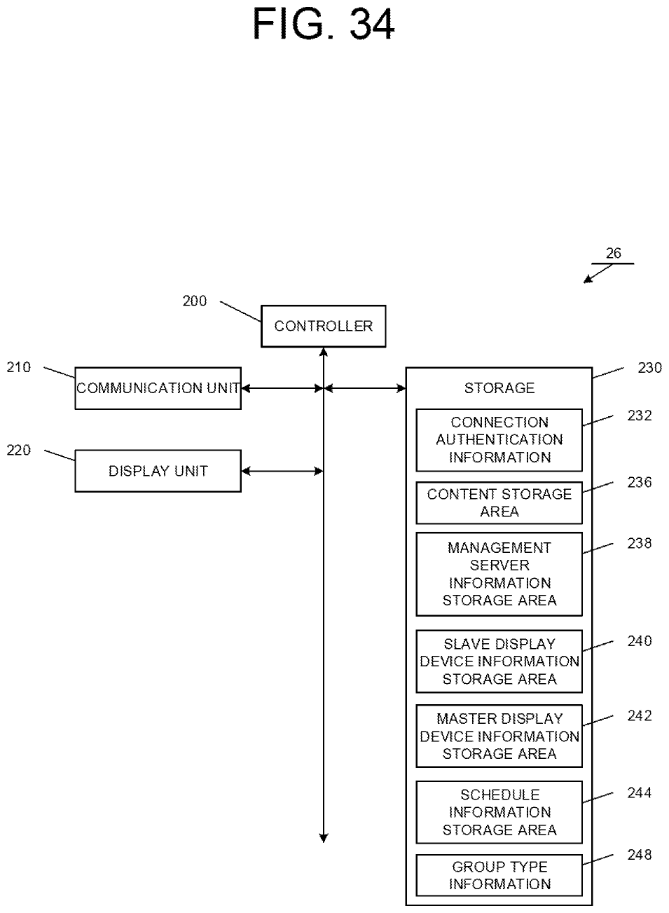

The fourth embodiment is an embodiment which is capable of specifying the content to be displayed using the schedule information storage area 130 of the second embodiment by means of group type rather than information relating to the group. The present embodiment replaces FIG. 2 of the second embodiment with FIG. 31, and FIG. 22 with FIG. 34. In addition, the same reference numerals are given to the same functional units and processing, and the description will be omitted.

### 4.1 Functional Configuration

### 4.1.1 Functional Configuration of Management Server Device

The functional configuration of a management server device 16 of the present embodiment will be described with reference to FIG. 31. The management server device 16 differs from the management server device 12 in that the storage 120 further stores group type information 132.

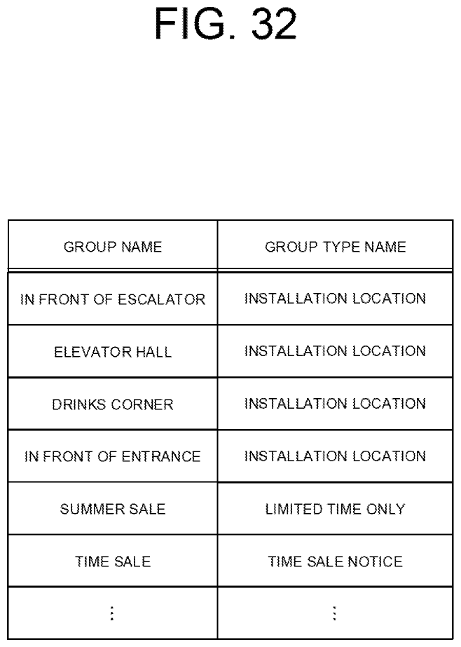

The group type information 132 is information that stores a group type for each group. FIG. 32 is a diagram showing group type information 132 in the present embodiment. As shown in FIG. 32, the group type information 132 stores a group name (for example, “in front of escalator”) for specifying a group, and a group type name (for example, “installation location”) indicating the group type. In the example in FIG. 32, “in front of elevator”, “elevator hall”, “drinks corner”, and “in front of entrance” each represent an “installation location” group to which devices belong according to the installation location.

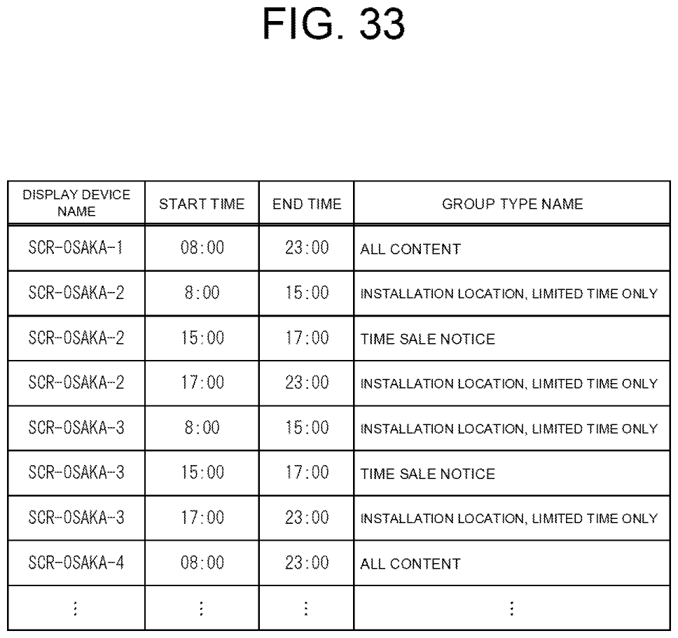

Furthermore, the schedule information storage area 130 of the present embodiment is shown in FIG. 33. The schedule information storage area 130 of the present embodiment differs from the schedule information storage area 130 of the second embodiment in that the content to be displayed is specified by a group type name rather than a group name.

As shown in FIG. 33, if the group content for a group whose group type is “installation location” and the group content for a group whose group type is “limited time only” are to be displayed, information such as “installation location, limited time only” is stored as the group type name. Furthermore, if all of the content stored in the display device 20 is to be displayed, information such as “all content” is stored as the group type name.

### 4.1.2 Functional Configuration of Display Device

The functional configuration of a display device 26 of the present embodiment will be described with reference to FIG. 34. The display device 26 differs from the display device 22 in that the storage 230 further stores group type information 248. The group type information 248 has the same structure as the group type information 132.

### 4.2 Processing Flow

The processing flow of the content transmission system 1 overall is the same as FIG. 23. However, if schedule information is transmitted from the management server device 10 to the display devices 20, the group type information 132 is transmitted together with the schedule information (S2002→S2004). The display devices 20 store the group type information 132 received from the management server device 10 as the group type information 248.

Furthermore, the content display processing is similar to FIG. 24. However, step S251 differs in that, after extracting the group type from the schedule information, the group name corresponding to the group type name is extracted from the group type information 248. The processing from step S252 onwards is the same.

According to the present embodiment, when content is displayed by the display device 20 according to the schedule information, schedule information does not have to be created based on the changed group even in a case where the belonging group of the display device 20 is changed. For example, if the group is changed when the installation location of the display devices 20 is changed, in the second embodiment it is necessary to create schedule information corresponding to the changed group, and to transmit the schedule information to the display device 20. However, according to the present embodiment, even if the group is changed when the installation location of the display device 20 is changed, it is not necessary to create schedule information corresponding to the changed group because the display device 20 determines the content to be displayed based on the group type. Therefore, more flexible operation of the content transmission system 1 becomes possible.

### 5. Fifth Embodiment

The fifth embodiment is an embodiment in which the third embodiment and the fourth embodiment have been combined. That is to say, the present embodiment is one in which the display device 20 is capable of changing groups, and further, the content to be displayed is determined based on the group type.

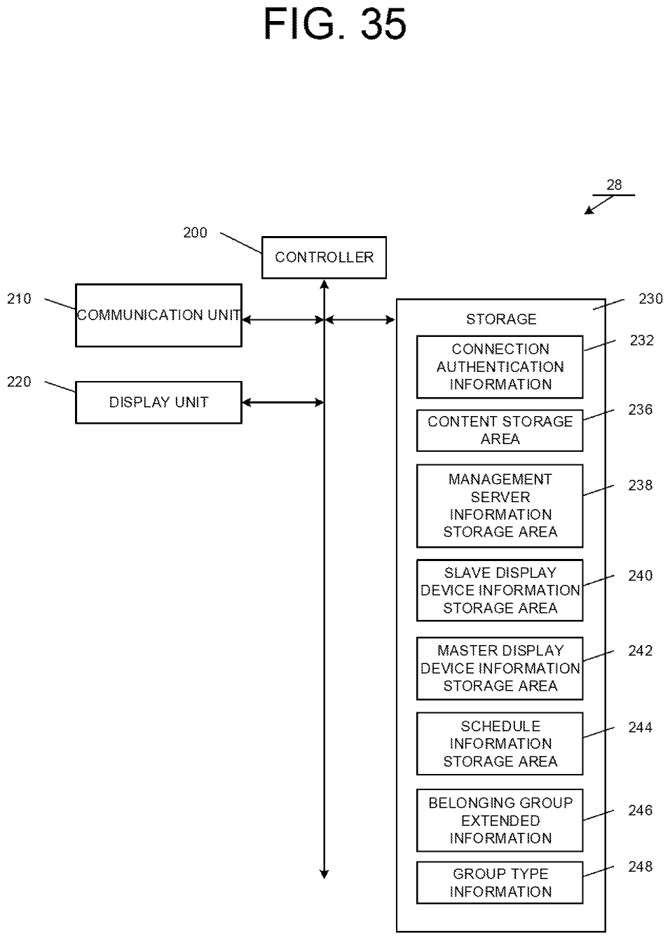

The content transmission system 1 of the present embodiment is constituted by the management server device 16 of the fourth embodiment, and a display device 28, in which the belonging group extended information 246 of the third embodiment is added to the display device 26 of the fourth embodiment. The functional configuration of the display device 28 is shown in FIG. 35.

The flow of processing to the flow of processing of the fourth embodiment. However, the management server device 10 transmits the belonging group extended information 246 to the display devices 20. Further, when the management server device 10 receives a belonging group change notification from a display device 20, the belonging group information in which the group to which the display device 20 belongs has been changed is stored in the belonging group information storage area 124. Furthermore, if an operation to change the belonging group is performed on the display device 20, a belonging group change notification is transmitted from the display device 20 to the management server device 10.

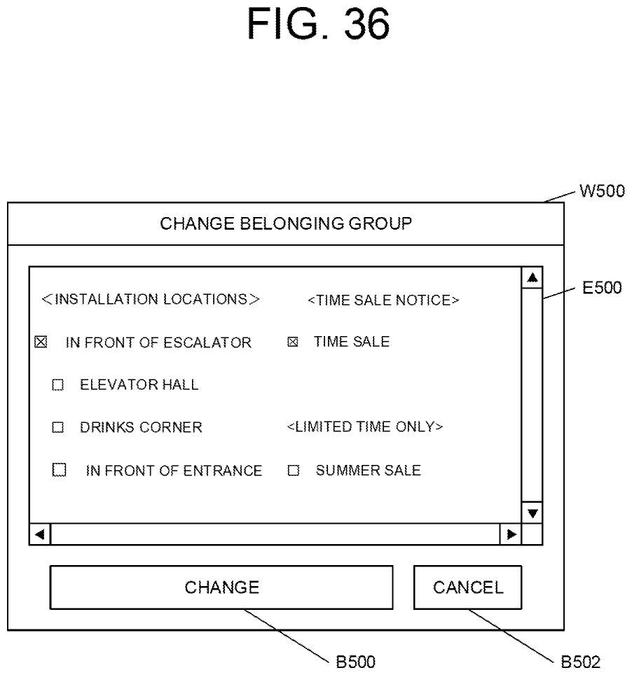

An example of a screen for changing a belonging group in the present embodiment is shown in FIG. 36. FIG. 36 is an example of a display screen W500, which is a belonging group changing screen displayed on a display device 20. This screen is a screen displayed by an administrator of the content transmission system 1 and the like. Furthermore, the display screen W500 includes a list area E500 for selecting a belonging group, a change button B500 for applying a change to the belonging group, and a cancel button B502 for closing the display screen W500 without changing the belonging group.

The list area E500 displays the group names for each group type. As in FIG. 30 of the third embodiment, group names may be displayed in a list irrespective of the group type. Furthermore, after the checkboxes are changed by an operation by an administrator of the content transmission system 1 and the like, the display device 20 transmits a belonging group change notification to the management server device 10 based on the state of the list area E300 if the change button B300 is selected. If the display device 20 belongs to a new group as a result of changing the belonging group, group content is transmitted to the display device 20 directly from the management server device 10 or from the master display device 20a of the new belonging group.

According to the present embodiment, it is possible to change the belonging group by operation of the display device 20. It is not necessary to create schedule information corresponding to the changed groups.

### 6. Modifications

The present invention is not limited to the embodiments described above, and various changes may be made. That is to say, embodiments obtained by combining technical means appropriately changed without departing from the scope of the present invention are also included in the technical scope of the present invention.

Furthermore, the embodiments described above have portions described separately for convenience of description, it is needless to say that they may be combined within a technically possible range.

Furthermore, in the embodiments, a program that operates in each device is a program that controls a CPU or the like (a program that causes a computer to function) so as to realize the functions of the embodiments described above. Further, the information handled by these devices is temporarily stored in a temporary storage device (such as a RAM) at the time of processing, and subsequently stored in storage devices such as various read only memories (ROMs) and HDDs. Then, the information is read, corrected, and written as necessary by the CPU.

Here, the recording medium that stores the program may be any of a semiconductor medium (such as a ROM or a non-volatile memory card), an optical recording medium or magneto-optical recording medium (such as a Digital Versatile Disc (DVD), a Magneto Optical Disc (MO), a Mini Disc (MD), a Compact Disc (CD), or a Blu-ray Disc (BD) (registered trademark)), a magnetic recording medium (such as a magnetic tape or a flexible disk), and the like. Furthermore, in addition to reading and executing the program to realize the functions of the embodiments described above, the functions of the present invention can be realized by joint processing between an operating system or other application programs based on the instructions from the program.

When distributed in the market, the program can be stored and distributed in a portable recording medium, or transferred to a server computer connected via a network such as the Internet. In this case, it is needless to say that the storage device of the server computer is included in the present invention.

What is claimed is:

1. A content transmission system comprising:
a content transmission device; and
a plurality of display devices, wherein
the content transmission device includes
a storage that stores content, and
a first controller that performs grouping of the plurality of display devices into one or more groups, stores grouping information, which is information relating to the grouping, in the storage, and transmits the grouping information and the content to one display device among the grouped display devices, and
the one display device includes a second controller that receives the grouping information and the content from the content transmission device, and transmits the received content to another display device included in the group based on the grouping information.

2. The content transmission system according to claim 1, wherein
the storage stores display device information relating to the display devices, and
the first controller determines the one display device from among the grouped display devices based on the display device information.

3. The content transmission system according to claim 2, wherein
the display device information includes information relating to a performance of the display devices, and
the first controller determines the one display device based on the performance of the display devices.

4. The content transmission system according to claim 1, wherein
the content transmission device preferentially transmits the content having a large transmission data amount when transmitting the content to the one display device.

5. The content transmission system according to claim 2, wherein
the display device information includes information relating to an attribute of the display devices, and
the first controller performs grouping of the plurality of display into one or more groups based on the attribute of the display devices.

6. The content transmission system according to claim 5, wherein
the first controller transmits belonging group information, which is information relating to groups to which the grouped display devices belong, to the plurality of display devices.

7. The content transmission system according to claim 1, wherein
another display device included in the group includes a third controller that transmits, to the content transmission device, a reception result indicating whether or not reception of the content has been completed normally, and
when the reception result indicates that reception of the content has not been completed normally, the first controller directly transmits the content to the other device included in the group and having transmitted the reception result.

8. A display device connectable to a content transmission device that manages a plurality of display devices by grouping the display devices into one or more groups, the display device comprising
a controller that receives content and grouping information, which is information relating to the grouped display devices, from the content transmission device, and transmits the content to another display device included in the group based on the grouping information.

9. A content transmission method for a display device connectable to a content transmission device that manages a plurality of display devices by grouping the display devices into one or more groups, the method comprising:
receiving content and grouping information, which is information relating to the grouped display devices, from the content transmission device; and
transmitting the content to another display device included in the group based on the grouping information.

10. A non-transitory recording medium storing a program for causing a computer of a display device connectable to a content transmission device that manages a plurality of display devices by grouping the display devices into one or more groups, to implement the content transmission method according to claim 9.
